(19) United States
(12) Patent Application Publication
(10) Pub. No.: US 2013/0110547 A1
(43) Pub. Date: May 2, 2013

(54) MEDICAL SOFTWARE APPLICATION AND MEDICAL COMMUNICATION SERVICES SOFTWARE APPLICATION

(71) Applicants: Karl Englund, Apple Valley, CA (US); Dennis Carson, Apple Valley, CA (US)

(72) Inventors: Karl Englund, Apple Valley, CA (US); Dennis Carson, Apple Valley, CA (US)

(73) Assignee: MASTER MOBILE PRODUCTS, LLC

(21) Appl. No.: 13/423,442

(22) Filed: Mar. 19, 2012

Related U.S. Application Data
(60) Provisional application No. 61/516,770, filed on Apr. 7, 2011.

(51) Int. Cl. G06F 19/00

(52) U.S. Cl. CPC G06F 19/322
USPC 705/3

(57) ABSTRACT

A portable electronic device includes a memory and processor. The memory stores automatic configuration instructions, which are part of a healthcare mobile software application (MedMaster Mobility) and called upon when the device attempts connectivity. The instructions cause the device to serve as an EHR-agnostic, native mobile tablet front-end solution to virtually any existing Health Information Technology (HIT) systems, thus allowing practitioners to use MedMaster Mobility at multiple facilities that may each be running a disparate HIT system. Built entirely on independent modules, MedMaster Mobility provides a seamless way to populate the Electronic Health record (EHR). It is designed to fit in the workflow, style and work habits of users. MedMaster Mobility is not a basic cluttered view of clinical data from a PC using a Web access client such as Remote Desktop type products.

### RELATED APPLICATION

This application claims priority under 35 U.S.C. §119(e) to U.S. Provisional Application Ser. No. 61/516,770 filed Apr. 7, 2011, entitled “Medical Software Application And Medical Communication Services Software Application” all of which is specifically incorporated by reference herein.

### BACKGROUND OF THE INVENTION

Technology has changed the way we live, but the healthcare industry, however, has lagged behind when it comes to using the power of modern technologies to improve our lives.

The lack of a standardized Application Programming Interface (API) for Electronic Health Records (EHR) on a mobile device such as mobile tablets is obstructing the growth of mobility for information networks. A standard interface is needed to support data exchange between EHR systems. Without a single standard method for EHRs to use to communicate, the healthcare industry can't advance with large-scale data exchange, despite the government's pumping of resources into Health Information Technology (HIT).

Payors are blocked by the lack of interoperability because it hinders their ability to conduct data analysis and predictive modeling. Then there are the vendors, who want standardization, but they have APIs of their own suites of products, so they're much less likely to press for a quick solution since they have a vested interest in their own products.

Without MedMaster, providers will have to make do with creating private mini-networks that exchange EHR data to demonstrate they can meet federally mandated “Meaningful Use requirements under the HITECH portion of the American Recovery and Reinvestment Act of 2009 (ARRA), which allocates funding for healthcare technology grants and per-physician Medicare and Medicaid incentives for those who achieve “Meaningful Use.” The private networks, limited as they may be, will enable providers to earn their incentive payments, but do nothing to promote the National Health Information Network.

The objectives of the National Health Information Network program is to use health IT to increase the quality and safety of patient care, improve the patient experience and to reduce costs. Some of the ways this can be done include getting healthcare quality data at the individual provider level and using it to provide feedback to those individual providers. It also means using IT to identify and reach out to patients with high blood pressure or other chronic conditions who haven't made appointments for a while, and engaging patients in their care by letting them download their own data and providing secure messaging and post-visit summaries and instructions. Some doctors originally feared that providing patients e-mail access would lead to a flood of messages from needy patients, but now it's considered “a no-brainer” that e-mails are much easier to manage than telephone calls.

In the past, primary care physicians, internists, residents, hospital and health plan administrators, and specialists (clinicians) never had at their fingertips their patient's electronic medical records, with history, physical, lab results, and imaging unless they used a Web-based browser on a Remote Desktop type connection. Physicians are searching for far more than what other mobile table device healthcare software solutions with their own proprietary APIs in the marketplace currently offer, which is a basic cluttered view of clinical data displayed from a PC on a smaller screen canvas such as a mobile tablet device and using a Web access client like Remote Desktop products.

In addition, healthcare information products were geared towards back-office procedures, such as billing and paperless office automation. Most medical products were not designed to easily interact with practitioners and their office staff directly.

Healthcare has traditionally been a system of distinct parties who must work together and form a service community. The parties include M.D.s, M.D. office staff, hospitals, surgical centers, diagnostic centers, home health agencies, nursing homes, insurance companies, federal and state government, patients, and ancillary service providers. Patients and their information are the common thread.

Healthcare professionals have had a difficult time managing a wide range of clinical and operational data, forever searching for ways to improve care in practice management, ambulatory electronic medical record (EMR), inpatient EMR, hospital billing, and to establish a better patient experience by providing a comfortable environment for both doctors and patients.

For group and solo physicians, mid-size and large medical groups, hospitals, integrated healthcare organizations, and purveyors of hospital/physician IT systems, MedMaster offers numerous tools to better manage time and overhead required to handle most patient insurance plans, including paperless eligibility retrieval, authorizations requests, claims submission, and payment status.

MedMaster improves a doctor's office's productivity by helping handle his daily patient schedule and allows additional resources to be spent on the most important thing—patient care.

Hospitals can manage on a real-time basis the overall level of performed services with reporting based on cost and patient demographics. In case management, reporting and data shared with physician groups will allow institutions to more actively handle inpatients and the related bed days.

There is a growing demand for structured, “actionable” information to be extracted from unstructured (dictated) medical documents. This demand is significantly fueled by the government's initiative for “Meaningful Use” which is aimed at promoting health care through improved quality, safety and efficiency. Healthcare organizations will be required to collect and report on quality and safety metrics with the aim of improving the cost/quality equation in healthcare. Additionally, such discrete data (unlike free-form narrative) will facilitate seamless and consistent interoperability and exchange of data between systems and sharing of information among providers within an integrated care continuum. In the long run, it will also enable broader application of evidence-based medicine and clinical decision support systems, providing the basis for a transition from pay-for-reporting to pay-for-performance.

The currently proposed solution by the industry is to rely on structured data input into EHR systems through the use of “point-and-click” user interfaces to select entries from pick-lists, instead of traditional free dictation methods. As a rule, physicians strongly resist these solutions, which are viewed as less efficient than direct dictation offered in MedMaster and are highly limiting in their ability to capture and document the unique clinical story for each patient encounter.

The good news for healthcare providers is that most of the information that is needed to comply with Meaningful Use requirements is routinely collected during patient encounters and are regularly captured in patient records. Although some of the information is typically collected by the nursing staff and is entered directly into the EHR, other data is gathered by physicians and is dictated as part of the clinical documentation process. This information is currently locked in unstructured free narrative dictations and is not readily available for automatic extraction, analysis or reporting.

One of the frequent concerns expressed by physicians is that relying on EHR templates significantly reduces their productivity, takes their focus away from the patient and limits their ability to accurately document the patient's story. It is possible, albeit costly, to hire teams of dedicated editors with clinical experience to solve this problem using manual editing and validation of text reports. A current and active debate in the healthcare informatics community is how to best leverage technology to develop a cost effective solution to automatically extract clinical facts from narratives and enter them into structured documentation to facilitate downstream processing and analysis.

The built in set of functionalities in MedMaster facilitate bridging the gap between the clinician's preferred narrative dictation method and the desired structured data output. This affords the physicians the best of both worlds—satisfy the Meaningful Use and EHR certification.

Today, most patient records are created through the process of verbally dictating a narrative report. Very little data arrives as structured data or is manually entered by physicians. Narrative dictation is the preferred mode of clinical documentation for most physicians.

With its synergistic-in-design software application that does not require complex training or expensive technology investments, MedMaster provides an innovative, affordable mobile solution to promote the National Health Information Network. MedMaster brings together health plans, hospitals, public and private practitioner, medical group administrators, clinics, providers, laboratories, and pharmacies 24/7 and from anywhere in the world. So, whether in the exam room, hospital room, or family room, the fully customizable intuitive graphical interface on the MedMaster-equipped mobile device such as the mobile tablet device provides clinicians the vital information they need by using built in speech recognition and navigation or with a simple tap on the mobile tablet device screen. With MedMaster, when doctors need to share health information they can forget the antiquated, difficult and time-consuming phone calls, frequent mailings, and faxes. And they can forget having to tote around a cumbersome laptop or remain stationary using a desktop computer.

MedMaster is very well positioned to be the right software solution to help physicians and organizations transition to healthcare mobility on a handheld device along with structured data creation, while enhancing adoption and utilization of EHR. With a speaker-adaptive engine that allows users to talk naturally and at their own pace, built-in visualization and feedback, voice navigation and correction capabilities, mobile device gesture support, and anytime, anywhere access, clinicians can rest assured that clinical information is accurate and up to date. MedMaster leverages the considerable benefits of speech technology to create the right solutions for each physician.

In real estate it's . . . location, location, location. But in healthcare it's . . . a standardized mobile native solution, a standardized mobile native solution, a standardized mobile native solution.

### BRIEF DESCRIPTION OF THE DRAWINGS

FIG. 1a & 1b illustrate an entire electronic health records system and dataflow between parts of the medical systems according to an embodiment of the invention.

FIG. 2 illustrates operation of a medical communications module translating a request according to an embodiment of the invention.

FIG. 3 illustrates operation of the auto-configurations module translating control records and data into another medical information system according to an embodiment of the invention.

FIG. 4 illustrates operation of the collaborations module translating allowing communication of data, images, video, news, and other forms of electronic information between individuals, private groups, public forums, and any combination thereof according to an embodiment of the invention.

FIG. 5 illustrates operation of the automatic image-watermarking module according to an embodiment of the invention.

FIG. 6a illustrates the Login View. Being EHR-agnostic, MedMaster Mobility conveniently serves as a native mobile tablet device mobile front-end solution to existing HIT systems without the need for complex re-training or expensive new technology investments.

FIG. 6b illustrates the Launch View. MedMaster Mobility's Launch Pad provides instant access to the most used functions using speech recognition for navigation or with just the tap of a finger on the device's screen. This view also shows the practitioner's name and current location above the eight core functions that among other workflows may include: My Schedule, My Patients, My Workups, Prescriptions, My Billing, SOAP, My Contacts, and My Resources.

FIG. 6c illustrates the Schedule View. The My Schedule view allows the doctor to instantly see the patients scheduled for the day. The Status (Checked-In, Checked-Out, Examined, No Show) of each patient is color-coded. The Appointment Time, Patient Name, Location, Room Number, and Orders are also displayed.

FIG. 6d illustrates the Patients' View. The Patient View is a comprehensive summary view of the patient's medical record that may be conveniently appended using speech recognition. This view displays personal information such as Name, Sex, Date of Birth, Address, Phone, Guarantor Information, and Insurance Information.

FIG. 6e illustrates the Patient Options View. The Patient Options View facilitates connections to the Patient's Full Chart, Order Diagnosis, Progress Notes, Allergies, Advanced Directives, etc.

FIG. 6f illustrates the Vitals View. The vitals taken here will automatically update the patient's record in the EHR database that the application is currently connected to and will also be available for use in the encounter notes, which may be keyed-in or dictated using the speech recognition engine.

FIG. 6g illustrates the My Workups View. The My Workups View defaults to show the doctor's patients with lab results that have not yet been reviewed. The labs can be plotted into graphs over selected date ranges, etc.

FIG. 6h illustrates the Prescriptions View. The Prescriptions View defaults to show the patient's Problem List and Medications.

FIG. 6i illustrates the My Billing View. The My Billing View defaults to show a list of patients on the left side of the screen, and on the right the ability to enter appropriate billing codes.

FIG. 6j illustrates the S.O.A.P. View. The SOAP module provides instant access to Current Medications, Diagnostic Codes, Plan Notes, and more. Using the built-in speech recognition, a doctor does not have to take his valuable time to type in all his S.O.A.P. notes.

FIG. 6k illustrates the My Contacts View. The My Contacts View may be divided into two or more groups such as Professional Connections and General Contacts.

FIG. 6l illustrates the My Resources View. The My Resources View provides instant access to answers to everyday legal questions with PDRs, ICD, CPT/HPCS and ARUP, along with office credentialing.

FIG. 7 illustrates MedMaster Mobility connectivity to an HIE exchange server. The HIE exchange server includes an integration server that supports a variety of messaging standards protocols for connecting to external systems and numerous databases for storing message data according to an embodiment of the invention.

### DETAILED DESCRIPTION OF THE INVENTION

MedMaster is an information-rich, yet physician-friendly mobile environment that combines the best of narrative dictation with the structure and organization of clinical data. It provides a seamless way to populate the Electronic Health record (EHR), accelerating adoption and helping facilities realize the full potential of their Health Information Technology (HIT) investments. It is designed to fit in the workflow, style and work habits of users, empowering physicians to focus on taking care of their patients without having to worry about the underlying technology. With clinical knowledge capture technology, detailed clinical documentation is naturally produced as a by-product of routine medical practice, and helps deliver safer, higher quality patient care.

MedMaster's quick, easy and cost-effective broad range of tools and capabilities is the ideal mobile solution for any size and type of healthcare provider to better coordinate and manage the delivery of patient care, fewer tests, overall cost reduction, and of course to maximize the long-term beneficial effects of the ARRA stimulus initiatives.

In compliance with HIPAA and other privacy standards, protecting the patient's right to privacy is an important issue. This sensitive and confidential information is safely and properly secured with MedMaster's robust security technologies, and of course, is never stored on the MedMaster-equipped mobile tablet device.

In an emergency requiring immediate notification to a doctor, a person with valid credentials can write a message and in seconds display it on the selected mobile tablet device screen even if the mobile tablet device is in sleep mode.

If lost, stolen or misplaced, a person with valid credentials can initiate a remote wipe of the given mobile tablet device to restore it to its factory settings. If the mobile tablet device is found, a simple connection to a computer with the use of iTunes the data on the given mobile tablet device may be restored its most recent backup.

The MedMaster healthcare mobile software application and the MedMaster medical communication services software application that automatically configures itself as it connects to virtually any legacy system whether cloud-based or on a local server with minimal impact on internal IT resources and without complex training or expensive technology investments (collectively commonly known as “MedMaster Mobility”), is built entirely on independent modules. Each module has a specific task and can be easily configured and customized while maintaining complete compatibility with each other.

For example, MedMaster Mobility's modules based on data objects, know how to use an object and its properties, regardless of the original data source. The communication services software solution is automatically configured by a single request (init) to MedMaster Mobility's software. So it doesn't matter if the original source is from an SQL database, a NoSQL database, or even XML.

Implemented by using executable files running on a file server, a group of web services, or scripts such as Perl, PHP, etc., our modules handle all requests for data objects via a central communications module. This module can be configured to communicate seamlessly and securely with a variety of methods, such as direct links to a port and database, web services, REST, SOAP, HTTPS, ODBC, API connections, or any combination of mechanisms.

The Communication Services Software Application is automatically configured by a single request (init) to the MedMaster Mobility software residing on the client's stationary server or cloud-based server. The XML response configures all of the options and behavior, from the method of communications used for each request to the data and format in which to expect the return response.

Implemented by using executable files running on a file server, a group of web services, or scripts such as Perl, PHP, etc., our modules handle all requests for data objects via a central communications module. This module can be configured to communicate seamlessly and securely with a variety of methods, such as direct links to a port and database, web services, REST, SOAP, HTTPS, ODBC, API connections, or any combination of mechanisms.

MedMaster Mobility has set the trend by auto-configuring connections to virtually any HIT system. This unique ability is achieved by having the client create a specific set of medical records. These “master” records are then sent to MedMaster Mobility via almost any standard data communications method such as SOAP, REST, XML, print capture, etc.

Once MedMaster Mobility receives the “master” records, it uses an internal Translation Service to detect specific, fields, their formats, etc. These fields are then data-mapped to MedMaster's native database format. This unique process saves enormous amounts of time and effort normally required to manually map data from one system to another.

MedMaster Mobility connects directly to the cloud using secure Internet connections so that no data is ever stored on the device itself, thus making MedMaster Mobility 100% secure and HIPAA compliant. MedMaster Mobility uses one of the largest cloud services available. Our cloud servers are amazingly fast and do all of the complex processing, keeping MedMaster Mobility nimble and efficient.

The core MedMaster Mobility software application is fully customizable, and serves as a single standard interface; secure front-end native mobile solution for virtually any legacy EHR provider. This allows practitioners to use MedMaster Mobility at multiple facilities that may each be running a disparate Health Information Technology (HIT) system, and all with accuracy never before possible using speech recognition and navigation or a simple tap on the mobile tablet device screen.

The system (the mobile tablet device coupled with our MedMaster Mobility software solution), uses 256-bit speech recognition to navigate the software solution or a simple tap on the touch screen interface to access nearly every feature a clinician would need to manage the wide range of clinical and operational data, including one-touch access to Scheduling, Billing, Workups, Patients, SOAP, Prescriptions, External Resources, and Contacts.

For Scheduling, MedMaster Mobility provides the ability to easily view and schedule office visits, hospital rounds, surgeries, and transfers from facility to facility.

For Billing, MedMaster Mobility includes clearinghouse availability, tracking accounts receivable aging, and insurance verification.

For Workups, MedMaster Mobility features an intuitive thought process that flows as the clinician thinks with his or her preference settings to ensure clinical decisions are efficient. MedMaster Mobility also provides voice recognition and dictation compatibility, safe and accurate distribution of practitioner' resources, template driven notes to capture discrete data, and can preload progress notes based on common visit types and carry previous visits forward.

For Patients, MedMaster Mobility manages caseloads and time with instant patient accessibility.

For SOAP, MedMaster Mobility affords the doctor the ability to perform a Subjective and Objective Patient Assessment followed by Treatment Plan

For Prescriptions, MedMaster Mobility is fully customizable by the user's location and insurance preferences, and includes instant drug interactions and Physicians' Desk Reference and refill requests.

For External Resources, MedMaster Mobility provides answers to everyday legal questions with PDRs, ICD, CPT/HPCS and ARUP, along with office credentialing.

For Contacts, MedMaster includes a list of credentialed facilities, together with specialists and personal contacts.

After logging in, MedMaster Mobility displays a main screen with the most accessed functions of the application. These buttons are shortcuts to features, but many of the features will overlap during use of the application.

With MedMaster Mobility clinicians enjoy unlimited speech dictation and navigation usage. This model eliminates any cost concern a doctor may have with respect to just how often and how much he would use speech recognition for dictation and/or navigation.

Doctors can dictate patient notes on-the-go in real-time three times faster and with no external microphone needed. And with cloud-based speech recognition, clinicians always have access to the latest medical dictionary, terms, phrases and clinical formatting rules, and the speech-related data is communicated over 256-bit encryption channels to ensure end-to-end security.

MedMaster Mobility was designed from the very beginning to be a native mobile tablet device application and to provide the ultimate and intuitive mobile tablet device experience that only a truly native application can do. The advantages of MedMaster Mobility as a native mobile tablet device solution include:

(a) Gives users the experience they have come to expect on the mobile tablet device device

(b) The application is an extremely friendly and has a powerful graphical user interface

(c) Devices (mobile tablet device) can be authenticated per location

(d) No patient data is ever stored on device

(e) Ability to perform “over the air” updates

(f) Ability to “push” notifications directly linked to specific patients or data

(g) Remote Device Management

(h) Remote Wipe

(i) Location information can automatically be included in data access tracking, thus reducing the possibility of malpractice claims

MedMaster Mobility is significantly more than a basic cluttered view of clinical data from a PC using a Web access client such as Remote Desktop. No more squinting, pinching or zooming to view data in the proper input field.

Using a Remote Desktop type client on the mobile tablet device instead of a native application such as MedMaster Mobility can only deliver less than acceptable results, given that currently the Remote Desktop audio receiver on an iOS device (iPhone/mobile tablet device) lacks support for any bi-directional audio such as speech recognition and navigation.

Bi-directional audio is the audio that is captured by the iOS device that needs to be transmitted to the Remote Desktop receiver first and that receiver in turn takes that audio and sends it to the host application that resides on a Remote Desktop server. The current lack of functionality is in the first step where the iOS device and the Remote Desktop receiver are unable to exchange the captured audio between each other, a necessary bi-directional step for speech recognition software to function on a Remote Desktop type connection.

Since MedMaster Mobility is not a Remote Desktop type based solution, these problems are completely eliminated once and for all.

And with MedMaster Mobility, internal IT resources won't face the inevitable probability of obsolescence in: (a) Full HIE Mobile Interoperability, (b) and Medical Speech Recognition and Navigation, and (c) Unstructured free narrative dictations that is not readily available for automatic extraction, analysis or reporting.

Integrated into MedMaster Mobility as a standard component is software that leverages advancements in Natural Language Processing (NLP), medical Artificial Intelligence (AI) and speech recognition technology to create tailored solutions for healthcare informatics. It offers the following benefits:

(a) Capture the uniqueness of each patient encounter and document the clinical decision-making process without the limitations of rigid documentation “templates”

(b) Computer-Assisted Physician Documentation (CAPD) helps physicians create ICD-9-compliant clinical documentation today and streamlines the transition from ICD-9 to ICD-10 in the future. The transition to ICD-10 is occurring because ICD-9 produces limited data about patients' medical conditions and hospital inpatient procedures. ICD-9 is 30 years old, has outdated terms, and is inconsistent with current medical practice. Also, the structure of ICD-9 limits the number of new codes that can be created, and many ICD-9 categories are full.

(c) Unlike blocks of free-text, key patient data is identified and automatically saved as structured data in the EHR's database, where information can be analyzed, reported and used for better patient care

(d) Analyzes free text dictation, and then tags the most important clinical data elements such as medications, problems, social history, allergies, and procedures

(e) Streamlines EHR population from the narrative by automatically extracting clinical facts from dictation and then placing that data into the appropriate fields in each respective form

(f) Facilitates more accurate coding

(g) Finish notes more quickly, thus enabling more one-on-one time with patients, which enhances patient satisfaction and outcomes

(h) Ensures that the spelling of some inanely spelled medication will be correct

(i) Preserves the patient's unique clinical story by eliminating point-and-click and reliance on keyboard and mouse

(j) Enables physicians to document their clinical decision making processes

(k) Integrates into physician and enterprise workflows

(l) Support compliance with CCHIT EHR certification criteria

Healthcare reform, federal and state quality initiatives, and the move to outcomes-based payments are creating a complex new environment within the healthcare field. These changes are challenging the way physicians document patient episodes and the way hospitals ensure that physician documentation appropriately captures the level of care provided to each patient.

As a standard component tightly integrated into MedMaster Mobility is software that will ease the pressures of the complex transition to the ICD-10 coding system that will put clinical documentation tools and processes, and Clinical Documentation Improvement (CDI) programs, to an even greater test. Highly specific, exhaustive, and clearly recorded patient information will be critical to maintain existing levels of reimbursement, ensure the accuracy of performance reports, and reap the benefits of this more articulate and flexible coding system.

As the pace of healthcare payment reform initiatives accelerate, hospitals face an ever-increasing burden to ensure that physician documentation meets the requirements of ICD-9 coding today and ICD-10 coding in the near future. Physicians face mounting pressure to produce better, more precise clinical documentation while they continue to work to provide the highest level of care for their patients. The nation's healthcare system is being transformed into one that rewards and reimburses providers for quality and outcomes. As part of these larger initiatives, new reimbursement models are being introduced, making complete and compliant codes even more critical without the software tightly integrated into MedMaster Mobility as a standard component.

Soon the ICD-10 classification system will replace ICD-9-CM as the national coding standard used to record, store, and retrieve diagnosis and procedure information for clinical and quality purposes, as well as for healthcare reimbursement. The long-awaited adoption of ICD-10 will drive healthcare improvement by enabling accurate identification and payment of new procedures and better understanding of health conditions and outcomes. However, the transition will not be easy. Many analysts estimate transition costs will total hundreds of millions of dollars nationwide. Most of these costs will go into adapting existing processes and tools to meet the new requirements in documentation.

Diagnostic and procedural categories of ICD-10 contain five times more codes than ICD-9, meaning that five times more subtypes of diagnoses and procedures can be captured and billed—as long as they are documented properly. For example, there is only one code in ICD-9 for the suture of an artery, no matter if the physician is repairing a minor cut or a major stab wound. There are more than 180 codes in ICD-10 for the same procedure, making it possible to accurately capture patient acuity.

Furthermore, an ICD-10 code can comprise as many as seven digits; ICD-9 has just five. To compute the additional digits, such details as the laterality and extension of a lesion or the severity of a diagnosis are required.

The following example shows the more detailed information gained through the added digits:
S52 Fracture of forearm
S52.5 Fracture of lower end of radius
S52.52 Torus fracture of lower end of radius
S52.521 Torus fracture of lower end of right radius
S52.521A Torus fracture of lower end of right radius, initial encounter for closed fracture

ICD-10 is a more expressive and flexible language for capturing precise patient information and sharing it among physicians, payers, and reporting agencies and, ultimately, the patients themselves. To this extent, ICD-9 codes have proved to be inadequate for representing patients' conditions for any purpose outside of billing. ICD-10 brings greater granularity and richness to coded data, supporting clinical research and outcomes measures, and promoting more accurate reimbursement. However, its complexity will challenge physicians' ability to provide complete documentation. Experience in other countries that have already made the ICD-10 transition demonstrated that training of physicians and staffs, as well as increased documentation time, are significant costs associated with the ICD-9 to ICD-10 transition.

Computer-Assisted Physician Documentation will help physicians capture all the information needed for coding in ICD-10, in real time, at the point of documentation without manual data entry. By enabling physicians to capture detailed, complete documentation upfront, CDI specialists have fewer documentation gaps to address, and coders have the information they need to get to the most appropriate codes for each patient.

Unlike what may be termed “single-purpose” mobility from various EHR providers intended to function only with their respective systems, MedMaster assures safe and secure delivery using a standardized mobile tablet device interface of the six critical rights of information management and exchange: getting the right information to the right person at the right time in the right place in the right format for the right value, even from different HIE systems from anywhere at anytime.

Instead, MedMaster Mobility effortlessly enables stakeholders such as hospitals, labs, pharmacies, clinics, payers, patients and other healthcare organizations to easily connect, and share lab or test results, ER visits, referrals, medications, allergies, and more, in real time. Doctors and patients alike are assured safe and secure delivery of the right health information to the right place at the right time, and all in real time.

MedMaster Mobility ensures that whether or not a healthcare provider uses Epic, Allscripts, Cerner, GE Healthcare, Open EMR, Open Vista, World Vista, Practice Fusion, NextGen, or any of the other leading EHR or EMR solution, clinicians will have direct access to their choice of clinical documentation workflow without the use of a Web-based Remote Desktop type solution and their data will populate the right elements of the EHR or EMR without the need to carry around multiple mobile tablet devices (or other tablets for that matter) each equipped with one of these single-purpose mobility solutions. And with MedMaster Mobility they only have to learn its standardized interface instead of several systems.

For example, Dr. Jones starts his day in his private office, which uses HIT provider #1 and is connected to MedMaster Mobility.

The scheduler allows Dr. Jones to instantly see the patients scheduled for today. The Status (Checked-In, Checked-Out, Examined, No Show) of each patient is color-coded. The Appointment Time, Patient Name, Location, and Room Number are also displayed.

The My Schedule view continues with the ability for Dr. Jones to instantly see and record new vitals for the patient that is checked in by tapping on their record or navigating to it using built in speech recognition. Vitals taken here will automatically update the patient's medical record. In most fields, such as encounter notes, MedMaster Mobility allows Dr. Jones the option to either key-in or to dictate the information using speech recognition.

The My Patients view allows Dr. Jones to search patient records, see the patients who are scheduled for that day, etc. The results are displayed in the left pane. Selecting a patient from the list will display an overview of their Electronic Health Record on the left.

The summary view shows personal information, insurance information, and guarantor information. Using speech recognition or with the tap of a finger Dr. Jones can access the patient's full Chart, Orders, Progress Notes, Allergies, and more.

Later that day Dr. Jones starts his rounds by going to hospital “A” where he has privileges and which uses HIT provider #2 and is connected to MedMaster Mobility.

The Patient Chart view is a comprehensive view of the patient's medical record which Dr. Jones may dictate easily using speech recognition. Each of the Active Problems, Lab Results, etc. can be selected to see the full details.

After leaving hospital “A” Dr. Jones continues his rounds with a visit to hospital “B” where he also has privileges and which uses HIT provider #3 and is connected to MedMaster Mobility.

The My Workups view defaults to show his patients with lab results that have not yet been reviewed. The lab results can be plotted into several graph types, and can use custom filters, date ranges, etc.

When he's done with his rounds, Dr. Jones returns to his office, which as we know, operates on HIT provider #1. MedMaster Mobility connects to its database and displays the data. The S.O.A.P. view allows Dr. Jones to walk through a patient encounter in a familiar and logical manner.

The S.O.A.P. module provides instant access to Current Medications, Diagnostic Codes, Plan Notes, etc. Using speech recognition built into MedMaster Mobility, Dr. Jones does not have to take his valuable time to type in all his S.O.A.P. notes.

Medical speech recognition lets Dr. Jones document while on the go. He can speak naturally and at his own pace with access to the latest medical vocabularies. Speech-related data is communicated over 256-bit encryptions channels to ensure end-to-end security. Visual speech indicators and voice navigation and commands ensure a seamless end user experience.

As can be seen in this scenario, Dr. Jones used the MedMaster Mobility solution with advanced speech recognition dictation and navigation built right into our native mobile tablet device Application. His productivity increased dramatically, and allowed him to provide better care and to see more patients.

With medical speech recognition, and built-in-universal interoperability regardless of location, MedMaster Mobility is truly a physician's quintessential daily companion. MedMaster increases the number of patients that can be seen while improving accuracy.

MedMaster Mobility is designed to seamlessly and effortlessly connects to a Health Information Exchange (HIE) platform that is specifically designed for HL7 message integration. A cloud-based, feature-rich, fully customizable, complete EMR agnostic solution, the HIE platform does all the heavy lifting to transform and route healthcare data by facilitating various applications to communicate with any number of disparate health information systems. The HIE platform provides for easy exchange of data for all community participants, regardless of EHR vendor solutions including practices with none at all.

The HIE platform is a clinical data repository that organizes and aggregates clinical data across multiple sources, and also includes a plug-in based Master Patient Index (MPI). It provides a seamless connection to all practices in the Accountable Care Organization (ACO) by importing data from all major EHR systems into the HIE platform.

Data may be imported in the following formats:

(a) XML, HL-7, CCR, or CCD

(b) Connectors to All Other EHR Systems

(c) Connectors to All Hospitals

(d) Connectors to ALL Laboratories

(e) Connectors to ALL Radiology Practices

(f) Specifically designed for HL7 message integration MedMaster Mobility connectivity options include:

### Concept 1

Use existing API's. This would be a SOAP or REST solution that would:

(a) Create a connection to API or web-services server

(b) Send request to API or web-service

(c) Receive and Parse the results

### Concept 2

Create an extremely thin middleware service to reside on a server. This thin client would be a REST solution, its only functions are:

(a) Create/maintain a connection to the appropriate database (SQL or NoSQL)

(b) Receive requests (via PHP or otherwise)

(c) Pass SQL/Query statement directly to the database

(d) Received the results

(e) Return XML or JSON response

Using MedMaster Mobility on a handheld device such as the mobile tablet device, the mobile solution provides both speech navigation and fingertip-access to various departments such as:

(a) Emergency room

(b) Inpatient pharmacy

(c) Radiology

(d) Operating room

(e) Anesthesia

(f) Intensive care

(g) Nurse triage

MedMaster Mobility is a fully scalable, patient-centric information solution that captures all clinical, financial and operational data related to a patient and organizes it into a consistent EMR. Regardless of the backend system (Epic, GE, etc.), MedMaster Mobility will serve and display all a practitioner's patients' electronic medical records in the same standardized graphical user interface (GUI), thus eliminating the need to learn a new system for every location and legacy system where he or she practices medicine, thus further assisting in making well-informed decisions.

MedMaster Mobility allows patients to interact with their practitioner by email or video chat, and to view test results and upcoming & past appointments, schedule appointments, pay bills securely and saving phone calls and mailing expenses, get automated health maintenance reminders, request refills, manage the care of elderly parents, and access benefit and eligibility information, referral authorizations and account balances.

The emphasis of MedMaster Mobility is to make practitioners more productive by simplifying the important elements of healthcare delivery. Efficient and virtually error-proof, MedMaster Mobility affords the practitioner a convenient, safe and secure solution for superior patient care at an affordable price, while reducing the possibility of malpractice claims and, of course, overhead by optimizing the use of staff and capital resources throughout the healthcare chain.

MedMaster Mobility provides integration of clinical data for use at the point of care, aids in clinical decision-making, required for meaningful use of EHR technology, offers interoperability for applications utilized in the physician practice environment, including Electronic Health Record (EHR), Personal Health Record (PHR), Computerized Physician Order Entry (CPOE), Clinical Decision Support (CDS), Picture Archiving along with Communications Systems (PACS), and E-prescribing.

MedMaster Mobility allows healthcare entities to implement as well as execute cost-containment strategies such as cost-effective revenue cycle processes, more efficient management of patients within systems, reduction of the accreditation and credentialing steps, provides a wealth of information at the time and place of care, provides reliable and accurate patient history, enables providers to perform a more accurate, focused patient evaluations, reduced costs to patients and healthcare system, and improved overall patient care.

The system (the mobile tablet device coupled with MedMaster Mobility), uses bi-directional speech recognition and navigation or a touch screen interface to access nearly every feature a clinician would need to manage the wide range of clinical and operational data, including one-touch access to scheduling, billing, workups, patients, prescriptions, external resources, contacts, and professional connections. It combines the mobile tablet device features with a magnetic stripe reader and software to speed patient check-in and payment transactions. This functionality and features may easily be transferred to other portable electronic devices, such as the iPod touch, iPhone, or other smartphones.

Using MedMaster Mobility cost savings start on day one, and generally fall under one or more of three key areas:

(a) Reduction in Transcription Costs

(b) Increase in (RVU) Relative Value Units/Reimbursement

(c) Physician Time Savings

Unlike other solutions that are not “LIVE” on line and require third-party transcription services, MedMaster Mobility eliminates 90%+ of those transcription costs, that's an average of $30,000 to $40,000 per year per physician. MedMaster Mobility can increase reimbursements by $5-10K+ per year per physician. It can also save an average of 22 minutes per day per physician.

### Further Detail on Additional Unique Features

### 1. MedMaster Communication Services

(a) Communication services connect MedMaster to any existing system without the use of additional server(s) or synchronization services.

### 2. Automatic Encrypted Watermark of Images

(a) MedMaster Mobility includes the ability to use an integrated camera or photo connection to capture medical images. When these images are obtained, MedMaster Mobility uses an algorithm to create a unique identifier for the image that also includes a checksum of the image. This identifier is then encrypted and stored within the image. This hidden “watermark” is not displayed in the image.

### 3. Protective Data Storage Method

(a) Data Stored in related databases in such a manner that no one database contains enough information to identify a person.

### 4. Data Padding and Randomization

(a) In the MedMaster Mobility system, the tables are padded to a sufficiently large number of records to dramatically increase the security of the “real” records. MedMaster Mobility uses a randomized method for locating a “padded” record and replacing the data to create “real” records as necessary. This process keeps the database size relatively consistent.

### 5. MedMaster Mobility Auto-Configuration

(a) MedMaster Mobility is capable of auto-configuring connections to most Medical Information Systems. This unique ability is achieved by having the client create a specific set of medical records. These “master” records are then sent to MedMaster Mobility via almost any standard data communications method.

### 6. Geo-Location to Determine Facility and Patients for Practioner

(a) Since the practitioner's network/Internet connection may be independent of the client's Medical Information Software, the Wi-Fi's network ID cannot be used to determine location. MedMaster Mobility's unique geo-location feature solves this issue and may reduce malpractice claims.

### 7. Integrated Magnetic Stripe Reader for Login

(a) MedMaster Mobility can use an optional magnetic stripe reader to read a practitioner's ID badge for security/login purposes. MedMaster Mobility can require a card swipe and authenticate the user for the client's Medical Information System. This allows devices to be maintained by an administrator and shared between employees with a very high level of security.

### 8. Speech Transcription for Soap Notes Automatically Recommends Standard ICD Billing Codes

(a) MedMaster Mobility allows practitioners to dictate their SOAP and other patient notes. MedMaster Mobility's speech recognition modules transcribe the audible notes into written text. MedMaster Mobility uses a unique and self-adapting algorithm to recognize key words and phrases that were spoken/transcribed and then to display a recommendation of the latest IDC Billing Codes.

9. Combined Touch and Photo Signature for Medical Procedures

(a) For purposes of recording a patient's consent to a medical document, MedMaster Mobility can display the form, allow the user touch-screen signature pad, and automatically capture an image of the signatory. This provides undisputable proof of consent, which can result in dramatically lower malpractice claims and potential lawsuits.

10. Integrated cloud collaboration (private, group, and Public)

(a) MedMaster Mobility includes a unique cloud-based collaboration facility that allows practitioners to share questions, comments, audio, and video information. MedMaster Mobility features the unique ability to allow information to be shared privately, to specific members of a Group, or Publicly to MedMaster Mobility users. Another unique feature of this collaboration space is that it includes a security feature to place an item into a secure “library” and then the item can be “checked-out” by an authorized user. Security can limit access to any item to one person, thus assisting in HIPAA compliance.

### 11. Integrated Cloud Patient Portal

(a) MedMaster Mobility allows patients to interact with their practitioner by email or video chat, and to view test results and upcoming & past appointments, schedule appointments, pay bills securely and saving phone calls and mailing expenses, get automated health maintenance reminders, request refills, manage the care of elderly parents, and access benefit and eligibility information, referral authorizations and account balance

12. Cloud Based Medical Records Translation Library with Automatic Data Translation

(a) MedMaster Mobility offers a unique, Cloud Based Software as a Service solution that can be used for medical facilities to send/“check-in” an Electronic Health Record (EHR). This information is encrypted as it is sent over a secure connection and encrypted when stored in the library. Once stored in the library, one person can only check out the EHR record at a time with secured clearance. MedMaster Mobility will automatically determine the format of the data that the recipient's system is expecting.

### 13. Standardized Mobile Interface Between Existing Medical Information Systems

(a) MedMaster Mobility's unique mobile interface remains standardized regardless of the client's existing Medical Information Software. This allows practitioners to use MedMaster Mobility at multiple facilities that may each be running a different MIS system. This enables the doctor to become more productive and efficient since they only need to learn one standardized interface (MedMaster Mobility) instead of several systems.

14. Push Notifications with Uniquely Identifying Sounds

a. MedMaster Mobility can “push” notifications to practitioner's mobile device even if the practitioner is not currently running MedMaster Mobility. MedMaster Mobility also uses a series of unique sounds/tones to indicate to the practitioner the type and urgency of the message. The message can consist of text, image, hyperlinks, and action buttons. The notifications can occur even if the mobile device is in silent mode.

15. Use of Tactile (Touch) Pattern for Application and Record Security

(a) MedMaster Mobility includes a unique system of input for various security options. This feature is based on touch-screen technology, and allows the user to draw various customizable patterns. Each of these patterns can be used to indicate a specific function. The patterns and pattern complexity are customizable by the user.

### 16. Integrated Magnetic Stripe Reader for Payments

(a) MedMaster Mobility can use an optional magnetic stripe reader directly attached to a mobile device as a mobile tablet device. This magnetic stripe reader can be used to read a patient's payment card (Visa, MC, AMEX, Discover, etc.) as well as the patient's official ID card for payment and security purposes. The MedMaster application can read a card swipe and authenticate the payment or official ID.

### 17. Integrated Device Control and Monitoring

(a) MedMaster Mobility's cloud servers have the unique ability to not only “push”/force software updates, the servers can also monitor the Operating System (OS) version, applications installed, and various settings. This gives an administrator complete control and autonomy over the devices that the MedMaster client is installed on. This can protect an organization's HIPAA compliance by making sure all of the latest updates, security patches, etc. are installed. The application monitoring function can also reduce an organization's liability by making sure unauthorized content is not stored or accessed by the device.

### 18. General Benefits of Integrated Connectivity to External HIE Exchange Server

(a) Provides a healthcare platform that allows for integration of clinical data for use at the point of care and to aid in clinical decision-making, required for meaningful use of EHR technology

(b) Provides for interoperability for applications utilized in the physician practice environment, including the electronic health record (EHR), the personal health record (PHR), computerized physician order entry (CPOE), clinical decision support (CDS), picture archiving and communications systems (PACS), and e-prescribing. Allowing healthcare entities to implement and execute cost-containment strategies (for example, cost-effective revenue cycle processes, more efficient management of patients within systems, and a reduction of the laborious accreditation and credentialing steps)

(c) Provides a wealth of information at the time and place of care

(d) Provides reliable and accurate patient history

(e) Enables providers to perform a more accurate, focused patient evaluations

(f) Reduced costs to patients and healthcare system

(g) Improved overall patient care

### 19. General Benefits of Integrated Connectivity to External HIE Exchange Server for Physicians

(a) Facilitation of the exchange of patient information when there is a change in provider or a referral is made

(b) Reduced risk of lost or misplaced health information, including lab results, X-rays, and imaging reports

(c) Physician alerts to patient allergies

(d) Diminished need for patients to fill out forms and repeat information already provided

(e) Improved and timely communication between the patient and the physician via a secure Web portal

(f) Increase in security as electronic health information can be encoded so that only authorized individuals can view them

### 20. General Benefits of Integrated Connectivity to External HIE Exchange Server for Hospitals

(a) Hospitals are able to collaborate with and assist physicians to prevent readmissions and better manage patients

(b) Focus on the cost per episode and more broadly on the cost per capita along with the broader cost across the entire continuum for the entire population they serve

(c) Coordinate care to reduce outpatient sensitive admissions and hospital readmissions, and provide preventive and wellness care to keep people out of the hospital

(d) Allow for management and administration of bundled and capitated payment programs, and to focus on cost per episode and cost per capita

(e) Features a rich interface channel development and monitoring environment that allows a healthcare provider to generate filtered rules and transformation steps using an intuitive drag-and-drop template-based editor

(f) Real-time connection monitoring through the interface dashboard and message reprocessing through the message browser

(g) Includes an integration server that supports a variety of messaging standards protocols for connecting to external systems and numerous databases for storing message data

(h) Integrated alerting based on user-defined rules to continuously monitor a healthcare provider's interfaces and notify users to take action

(i) Cost Reduction:
1. Standardizing care
2. Removing unnecessary care, including reducing provider errors, preventable readmissions, avoidable conditions, and unnecessary diagnostic tests
3. Cost restructuring to use the lowest cost setting and provider possible for each service
4. Develop a system of specific care strategies such as medical homes and disease management to reduce overall hospital service demand
5. Redesign care focusing on the disease level, and engage physicians and clinic partners inside and outside the hospital, and continuously measure and improve performance

### 21. General Benefits of Integrated Connectivity to External HIE Exchange Server for Accountable Care Organizations (ACO)

(a) Provides the foundation for any ACO-Care system, and facilitates numerous transactional services that deliver information to agencies as APIs or Web services, thus allowing for the uninterrupted flow of data throughout the exchange on behalf of the ACO

(b) SAAS-based system available to every physician within the ACO, thus allowing a practice to poll the exchange and find a patient's medical record across the entire organization. Typically the medical record is restricted to labs, medications, vitals, immunizations, allergies, past/family/social history and problems. Sharing of chart notes requires prior permission from the physician

(c) Allows for the integration of physicians with disparate EHR systems as well. All certified EHR systems will be able to send and receive CCR (Continuity of Care Records) in order to achieve rapid and efficient exchange of information. By utilizing the native CCR functionality of EHR systems, a physician organization comprised of dozens of varying EHR systems can be integrated to the exchange quickly

### 22. General Benefits of Integrated Connectivity to External HIE Exchange Server for Patients

(a) Maximize Patient Safety. Open communication and timely feedback on patient safety and care experience via the patient portal

(b) Ability to improve Quality. Provide evidence-based care delivering improved outcomes compared with national, state and regional benchmarks; peer databases; internal standards; and patient and family experience

(c) Improve Affordability of Care. Costs will compare favorably with organizations providing comparable services

(d) Convenience. A seamless patient and family experience that is accessible and educational. Patients have a more clear understanding of their care needs and control of their overall health

(e) Control and Influence. Patients receive all necessary information to make knowledgeable and confident choices about their health conditions, treatment options and overall wellbeing by providing a patient-centric approach to care management

(f) Improved Personalized Relationships between doctor and patient

### 23. General Benefits of Integrated Connectivity to External HIE Exchange Server to all Other EHR Systems Connectors

(a) Connectors to All Hospitals
1. Through the use of the exchange import and export technologies, hospital interfaces into and out of the exchange can be quickly implemented for most hospital systems. Emergency Department (ED) personnel can quickly look up patient data from the exchange. ED personnel can also obtain all medications on file from all US pharmacies participating with RXHub/Surescripts via the exchange
2. The physician-hospital connectivity is critical for physicians to receive discharge summaries and hospital lab data. The hospitals also benefit by having access to patient medications and lab results from the surrounding physician community, especially within the Emergency Department

(b) Connectors to All Laboratories
1. Connections to numerous laboratories and Lab Information Systems (LIS), including reference labs, (LIS) such as Orchard, LabDaq, Fletcher-Flora and others. An interface can be created if the lab can import and export HL-7 data
2. Allows the ACO system to integrate all labs and LIS products easily and effortlessly, resulting in a solid patient record in the exchange that can be shared by all physicians under the ACO

(c) Connectors to all Radiology Practices
1. Can develop interfaces with numerous radiology and MRI units to create PACS links and allow providers to view radiology and MRI images easily from within the ACO. The exchange server will not alter or modify the images, and will make them available through interface devices so physicians can securely view radiology results for their patients
2. Radiology reports are stored securely in the exchange to maximize data sharing capabilities

### 24. General Benefits of Integrated Medical Speech Recognition

(a) 3× faster than typing. Most physicians speak over 120 wpm, but type less than 40 wpm. Speech recognition lets a user document while on the go in ⅓ the time

(b) Speak at your own pace. Speak naturally without having to wait for recognized text to appear on screen or navigation commands to be recognized

(c) Robust medical vocabulary. Cloud-based speech recognition means a doctor will always have access to the latest medical dictionary, terms, phrases and clinical formatting rules

(d) Visualization and feedback. Visual indicators tell you where speech is enabled, when audio is being captured and displays audio recording levels to ensure a seamless experience

(e) HIPAA-compliant speech recognition. Speech-related data is communicated over 256-bit encryption channels to ensure end-to-end security

(f) Voice navigation and commands. Navigate and make corrections using voice or control audio capture and text corrections using familiar gestures on mobile devices

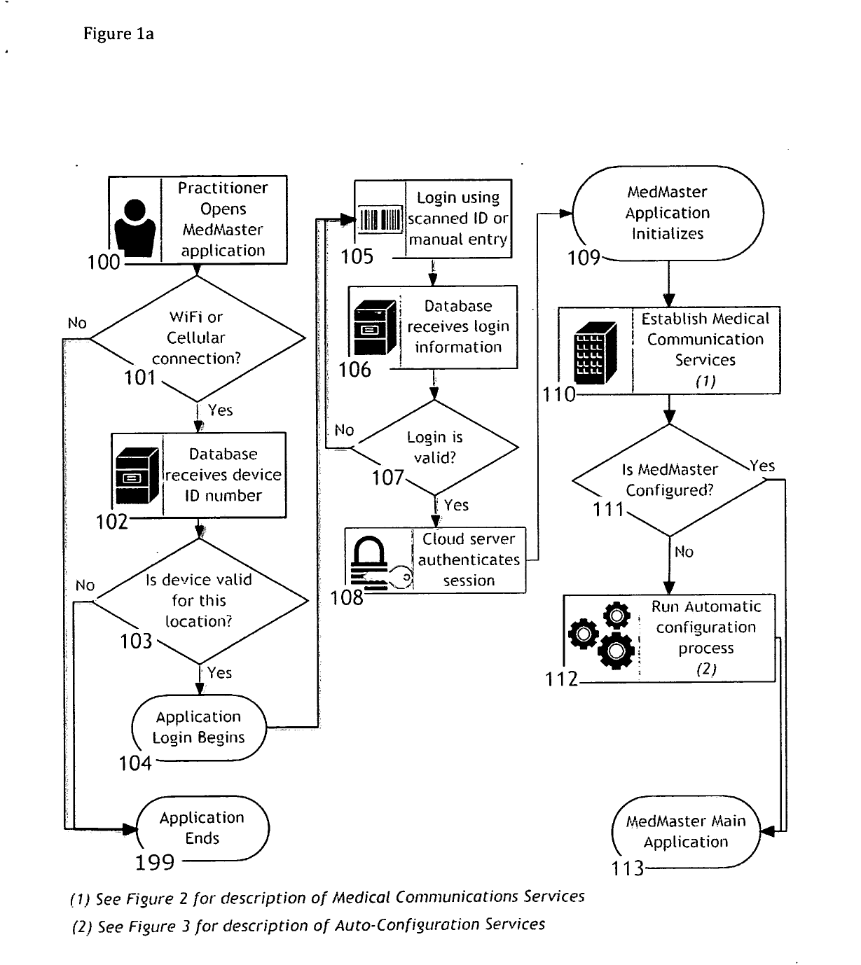

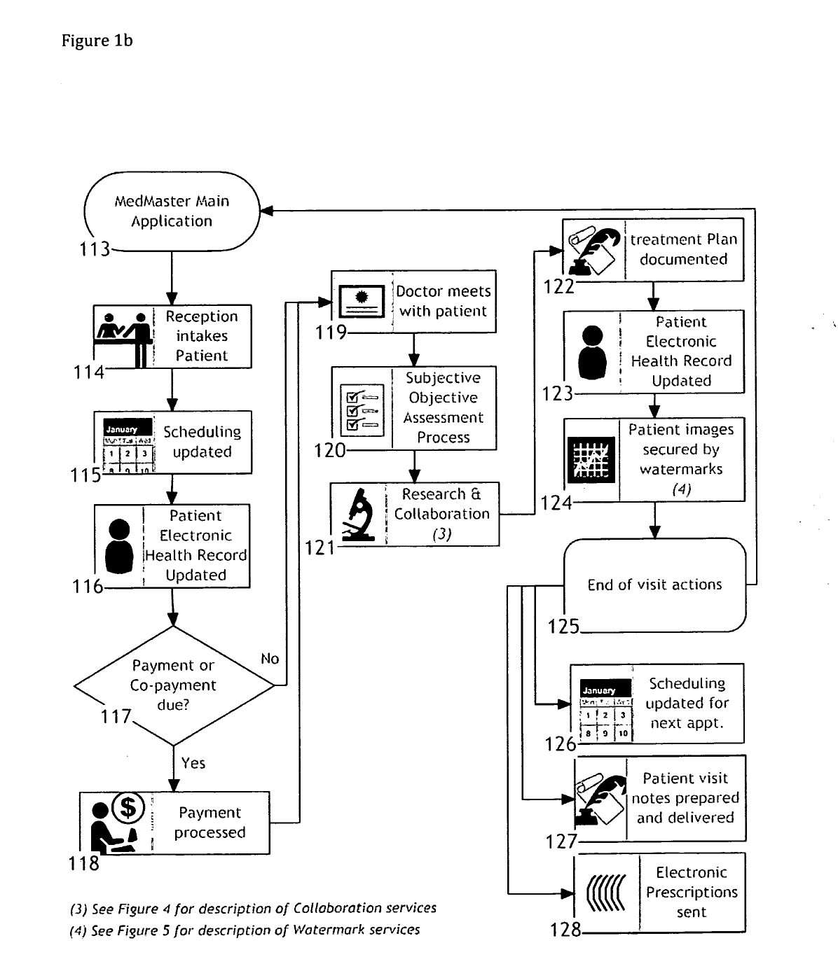

FIG. 1a & 1b illustrate A COMPUTER-IMPLEMENTED PROCESS FOR AN ENTIRE ELECTRONIC HEALTH RECORDS SYSTEM AND DATAFLOW BETWEEN PARTS OF THE MEDICAL SYSTEMS ACCORDING TO AN EMBODIMENT OF THE INVENTION.

MedMaster may use a portable electronic device including a medical information software application according to an embodiment of the invention. The portable electronic device includes memory, a processor, non-volatile memory (such as a hard disk, a USB drive or a memory card), an input/output device that may include magnetic stripe reader, and a battery, a display, a payment-receiving device, and the medical information mobile software. The medical information mobile software including instructions are stored in the non-volatile memory and are executed by the processor to cause the portable electronic device to perform the computer-implemented method. The medical information mobile software application may be referred to hereinafter by a number of names, including MedMaster mobile software application, MedMaster Mobility, the medical information software application and the MedMaster Mobile EHR software application.

The portable electronic device communicates with a medical information server, which can be resident in the medical location, or that may physically reside in a remote location. In an embodiment of the invention, the medical location may have an existing server, with which the medical information mobile software application may communicate directly. If the medical location does not have a server, the medical information mobile software application may connect with the remote medical information server.

In an embodiment of the invention, if the user does not have an existing EHR (Electronic Health Record) system, the user may install a medical information server. The medical information server may run software applications that perform a number of functions. The medical information server may include Electronic Health Record (EHR) server functionality and software, Patient Management server (PM) functionality and software, and an email server. Further, the medical information server may include a medical imaging database for storing patient scans, x-rays, and other medical images. The medical information server may include an electronic health records database to identify medical information for each patient. In an embodiment of the invention, the medical information server may also be referred to as an existing electronic medical record software application or an existing patient server. Even if the term server is utilized, this still refers to the software applications running on the identified server. In the medical industry, there are many naming conventions for the medical information server, such as described above, and practitioners may have many different names. Thus, the use of medical information server should not be limiting in that the medical information server may include functionality such as EHR functionality, Patient Management functionality, Electronic Prescriptions, Medical Transcriptions, Billing Codes, Diagnostic Codes, database functionality and email functionality.

A practitioner with a portable electronic device opens 100 the medical information software application. The mobile medical information software application communicates 101 with the medical information server via Wi-Fi if Wi-Fi is available. If Wi-Fi is not available in the location, the medical information mobile software may communicate with the medical information server via the cellular phone network. If neither Wi-Fi nor a cellular data connection is available, the mobile medical information software application may transmit 199 an error message to the display of the portable electronic device notifying the user of the communication failure.

Referring to FIG. 1a, in an embodiment of the invention, the mobile medical information software on the portable electronic device transmits 102 its unique ID to the medical information server. The medical information server then verifies 103 that the portable electronic device (and/or the practitioner) is valid for this medical location and has an active status. If the device (and/or the practitioner) is not valid for this location, the mobile medical information software sends an error message, which is displayed on the portable electronic device and the mobile medical information software application ends 199.

The mobile medical information software application receives input identifying that a session is to begin 104. A practitioner utilizes the portable electronic device to login manually by typing a username and password, or optionally to scan 105 an identification card with barcode, and 106 the mobile medical information software application receives the login credentials. The mobile medical information application transmits 107 the security response. The medical information server determines 107 if the credentials are a valid item and if the credentials are not valid, the medical information server transmits a message to the mobile medical information application that the credentials are not valid, and the medical information server returns the user/practitioner to step 105.

If the credentials are valid, the medical information server transmits 108 a secured token for the session, which is passed 109 to the medical information software as it initializes. 110 the mobile medical information software application then establishes connection with the practitioner's medical information server. Once connection is established, the mobile medical information software 111 determines if the application has been configured for the practitioner's medical information server. If the practitioner's medical information servers have not been configured, 112 the mobile medical information software executes an automatic configuration process. The automatic configuration process requests control (sample) medical records from the medical information servers. The information is then received and used to perform an automatic data mapping process. Any unknown fields can be manually mapped. Once configuration is complete, the mobile medical information software main application begins.

The mobile medical information application software may also include an electronic health record module (or EHR software application). The electronic health record software application also includes, or interfaces with, a patient management database. The electronic health records database includes patient contact information, birth date information, medical history, medical images, emergency contact information, insurance and billing information. In an embodiment of the invention, a patient record in the electronic health record database may include a photo image of the patient, as well as electronic consent forms.

Referring to FIG. 1b, in an embodiment of the invention, 113 then mobile medical information software displays its main interface with one-touch access to all vital features. 114 a practitioner, their assistants, or their receptionist may perform intake functions for a patient. The intake process could include completion of medical forms, insurance verification, and reading of vital signs. 115 the status of the patient is now updated in the scheduling part of the medical information server and 116 the patient's electronic health record is updated. 117 The mobile medical information software will communicate with the medical information server to determine if a payment is due for the services being rendered. If payment is due 118 the mobile medical information software processes the payment via manual or electronically swiped methods.

In an embodiment of the invention, 119 a practitioner examines the patient. During the examination, the mobile medical information software will guide the practitioner through a 120 standard S.O.A.P. (Subjective, Objective, Assessment, and Plan) medical process. The mobile medical information software allows the practitioner to easily create encounter notes, review and order laboratory tests, review previous and update current medications, and check family history.

In an embodiment of the invention, 121 the practitioner 121 is also able to use the mobile medical information software's research and collaboration feature. The mobile medical information software includes a unique cloud based collaboration facility that allows practitioners to share questions, comments, audio, and video information. The mobile medical information software has the unique ability to allow information to be shared Privately, to specific members of a Group, or Publicly to the mobile medical information software's users. Another unique feature of this collaboration space is that it includes a security feature to place an item into a secure “library,” and then the item can be “checked-out” by an authorized user. Security can limit access to any item to one person, thus assisting in HIPAA compliance.

The mobile medical information software's unique collaboration space is an “electronic whiteboard” hosted by cloud servers. This electronic whiteboard can contain any combinations of text, images, audio, and video items. Annotations can be automatically color coded by users and overlaid as individual layers. A user can select to view any combination of layers as well as to view a timeline of the annotation

In an embodiment of the invention, 122 a treatment plan is created within the mobile medical software and is 123 transmitted to the medical information server and the patient's electronic health record is updated.

In an embodiment of the invention, 124 the practitioner may capture or review patient medical images. The mobile medical software includes the ability to use an integrated camera or photo connection to capture medical images. When these images are obtained, the mobile medical software uses an algorithm to create a unique identifier for the image that also includes a checksum of the image. This identifier is then encrypted and stored within the image. This hidden “watermark” is not displayed in the image.

When an image is opened, the mobile medical software will check for this hidden watermark and verify that the image has not been altered. This security feature can be used to assure that images are authentic and not doctored. This feature can result in reducing insurance fraud, and reduce malpractice claims.

In an embodiment of the invention 125, the mobile medical software application helps the practitioner complete a list of encounter actions. These actions may include 126 the scheduling of a follow-up appointment, laboratory tests, 127 the preparation and delivery of a detailed medical encounter visit notes, and 128 the preparation of manual or electronic prescriptions.

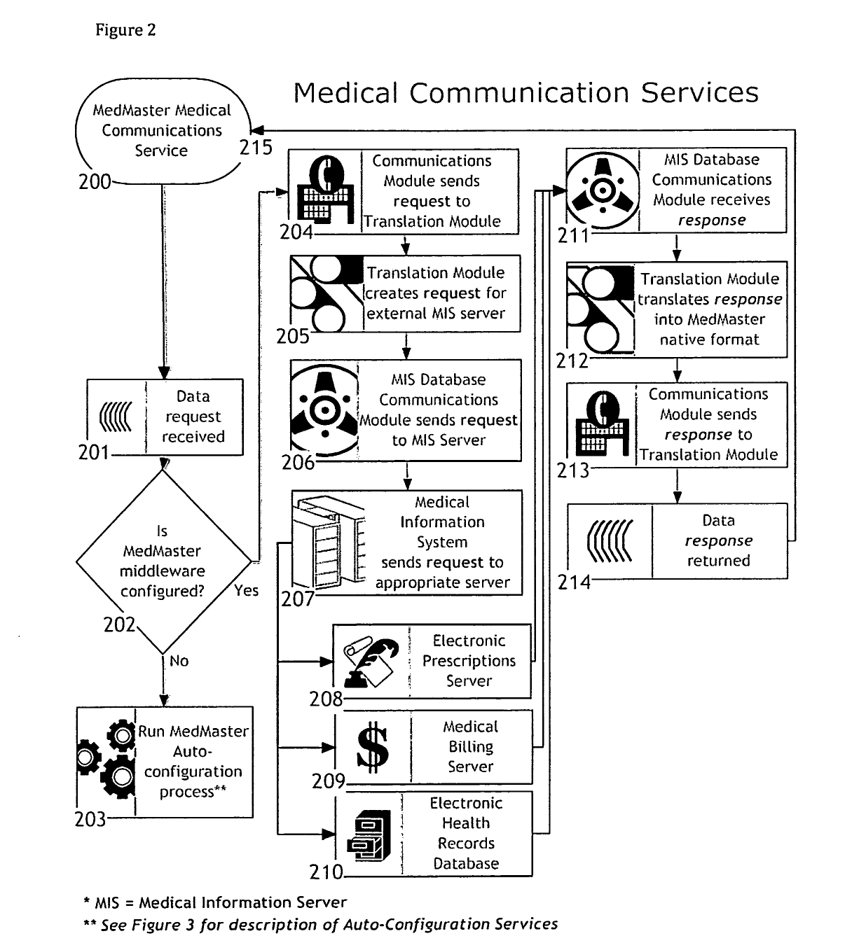

FIG. 2 illustrates AN ENTIRE MEDICAL INFORMATION SYSTEM AND DATAFLOW BETWEEN PARTS OF THE MEDICAL INFORMATION SYSTEM ACCORDING TO AN EMBODIMENT OF THE INVENTION. The entire mobile medical information system (201-214) includes portable electronic devices running the medical mobile medical information software application, a system including the medical information middleware servers (208), the existing medical information server 210, the existing medical billing server 209, and the electronic prescriptions server. The terms existing medical information software application and medical information server are used interchangeably within this application.

The medical information middleware software application 200 an internal communications module 204, a translations module 205, an MIS server connection module 206, and a configurations module 203. Each of these modules are software applications that are part of the medical information middleware software applications and that run on a computing device, such as a personal computer or server. The connections module 204 connects the medical information middleware software application to the existing medical servers (208, 209, and 210). In an embodiment of the invention, the internal communications module 204, the translations module 205, the connection module 206 and the configuration module 203 may reside on one physical computing device. In alternative embodiments, these modules may reside on multiple physical computing devices.

The communications service 201 may receive requests from the mobile medical information software application running on any of the portable electronic and may also transmit back the response (from the existing medical information server) to the mobile medical information software application on the requesting portable electronic device.

The translations module 205 of the medical information middleware software application may receive data in one format (e.g., a MedMaster defined format or other mobile medical defined format) and convert the data into a format understandable to the existing medical information server 206. In other words, in a legacy medical information server-compatible format.

The connection module 206 of the medical information middleware software application opens and establishes a channel of communications between the existing medical information servers (208, 209, and 210) and the different modules of the medical information middleware application software.

The configuration module 203 of the medical information middleware software application stores and controls feature sets and security options for different medical information servers and/or different portable electronic devices running the mobile medical information software application. The configuration module 203 may include a number of settings and configurations for different medical information servers systems (208, 209, and 210). In an alternative embodiment, the configuration module 203 may include settings and configurations for only one medical information server system (208-210). The configuration module 203 receives information regarding the medical information servers (208, 209, and 210) and the medical information middleware software application 200, as well as the communications that occur between the mobile medical information software applications running on portable electronic devices and the medical information middleware software application.

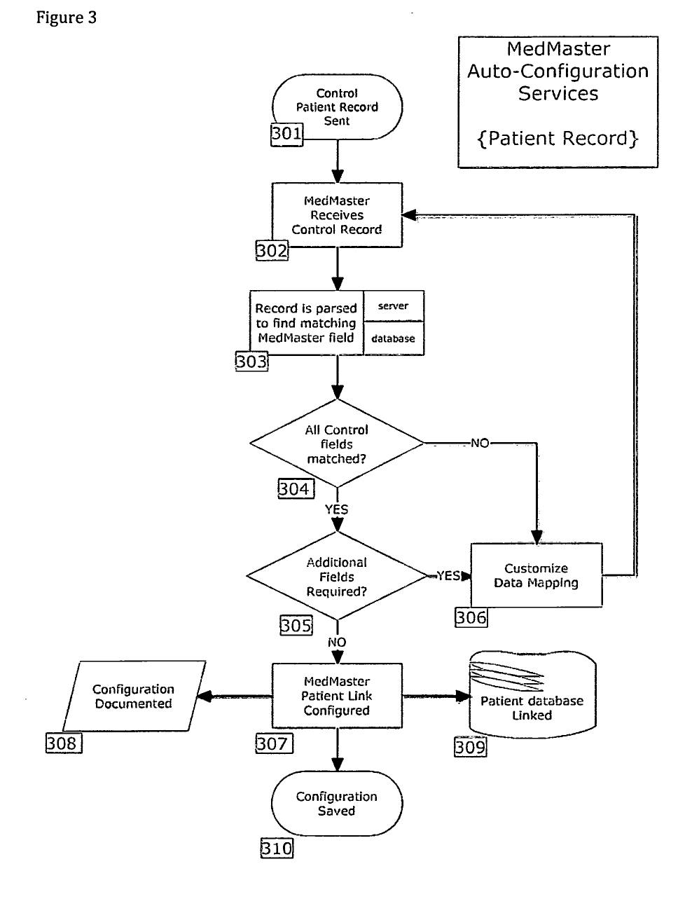

In a sample transaction, 200 the mobile medical information software sends a request to the medical communications service 201. The service checks 202 to see if it has been configured. If the middleware has not been configured, 203 the automatic-configuration service is run (see FIG. 3). If the service is configured, the 204 internal communications module sends the request to the 205 translation module. The translation module converts the request into a format that is native to the medical information servers and 206 forwards the request to the medical information service. The medical information service 207, forwards (if necessary) the request to the appropriate external server (208, 209, and 210) depending on the request type. The 211 MIS communications module receives the response and forwards it to 212 the translations module where the response is reformatted into the medical information software's native format. The 213 communications module 214 returns the response to the 215 medical information software, thus completing the request/response cycle.

FIG. 3 illustrates THE AUTOMATIC CONFIGURATION ROUTINE THAT CONNECTS THE MOBILE MEDICAL INFORMATION MIDDLEWARE TO AN EXISTING MEDICAL INFORMATION SOFTWARE SERVER. The medical information middleware system is capable of auto-configuring connections to most Medical Information Systems. This unique ability is achieved by having the client create a specific set of medical records. These “master” records are then sent to MedMaster via almost any standard data communications method such as SOAP, REST, XML, print capture, etc. Once the medical information middleware receives the “master” records, it uses an internal Translation Service, to detect specific, fields, their formats, etc. These fields are then data-mapped to MedMaster's native database format. This unique process saves enormous amounts of time and effort normally required to manually map data from one system to another.

If the medical information middleware detects that the connection to the existing medical information server has not been defined or has changed, 301 the medical information middleware requests a series of patient control records from the medical information server. 302 the medical information middleware receives the information in a raw or native format. The medical information middleware's translators 303 parse the responses and map each data field received to a format native to the mobile medical information software. 304 if there are unknown items in the response, the mobile medical information software provides an interface, which allows custom data mapping. In the case that additional fields are needed 305, the mobile medical information software provides an interface to define and map new data fields. After field validation 307 the medical information middleware software 308 documents the data mapping and validation results, 309 the database links are established, and 310 the configuration is saved.

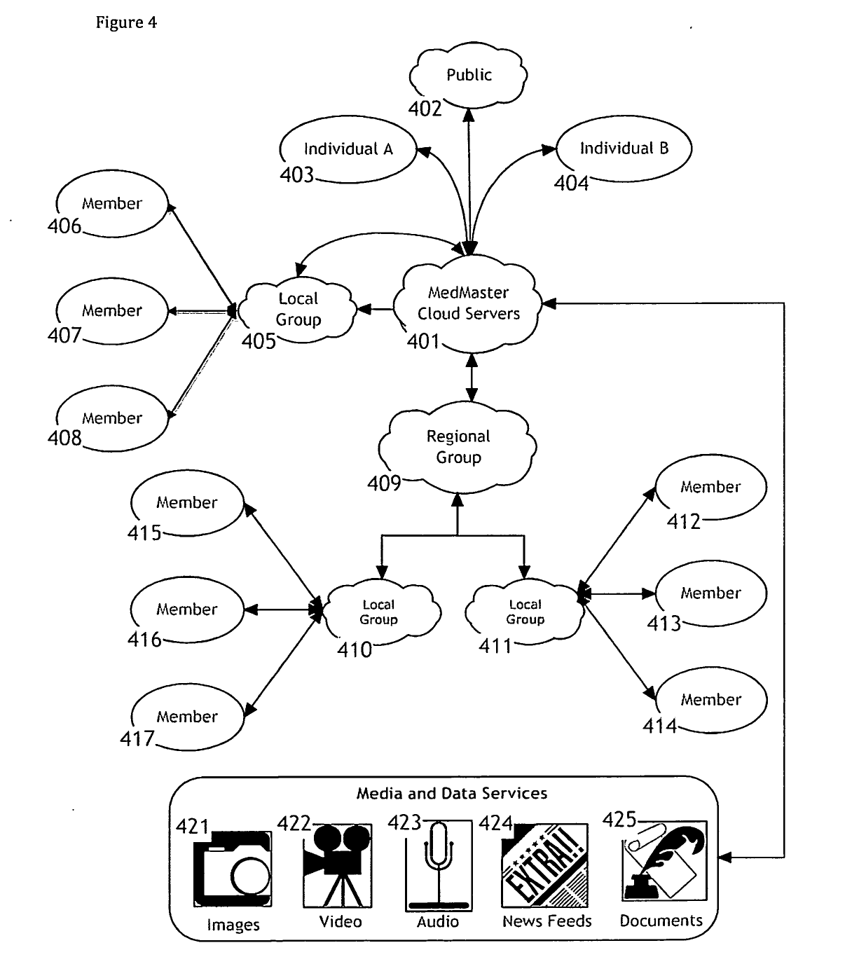

FIG. 4 illustrates INTEGRATED CLOUD COLLABORATION (PRIVATE, GROUP, and PUBLIC). The Mobile Medical Information Software includes a unique cloud based collaboration facility that allows practitioners to share questions, comments, audio, and video information. The mobile medical software has the unique ability to allow information to be shared Privately, to specific members of a Group, or Publicly to MedMaster users. Another unique feature of this collaboration space is that it includes a security feature to place an item into a secure “library,” and then the item can be “checked-out” by an authorized user. Security can limit access to any item to one person, thus assisting in HIPAA compliance.

The mobile medical information software's unique collaboration space is an “electronic whiteboard” hosted by cloud servers. This electronic whiteboard can contain any combinations of text, images, audio, and video items. Annotations can be automatically color coded by users and overlaid as individual layers. A user can select to view any combination of layers as well as to view a timeline of the annotation

In an embodiment of the invention, 401 the mobile medical information software uses cloud-based servers to hose the collaboration. The cloud servers 402 connect and maintain a public forum and can 403 and 404 connect to individual forum spaces. Users of the collaboration feature can 405 create a local group space that consists selected members (406, 407, and 408). 409 Regional groups that consist of multiple local groups (410 and 411) can also be created.

In an embodiment of the invention, all users, in all spaces, can create, maintain, and share any combination of Images (421), Video (422), Audio (423), RSS news feeds (424), and electronic documents (425).

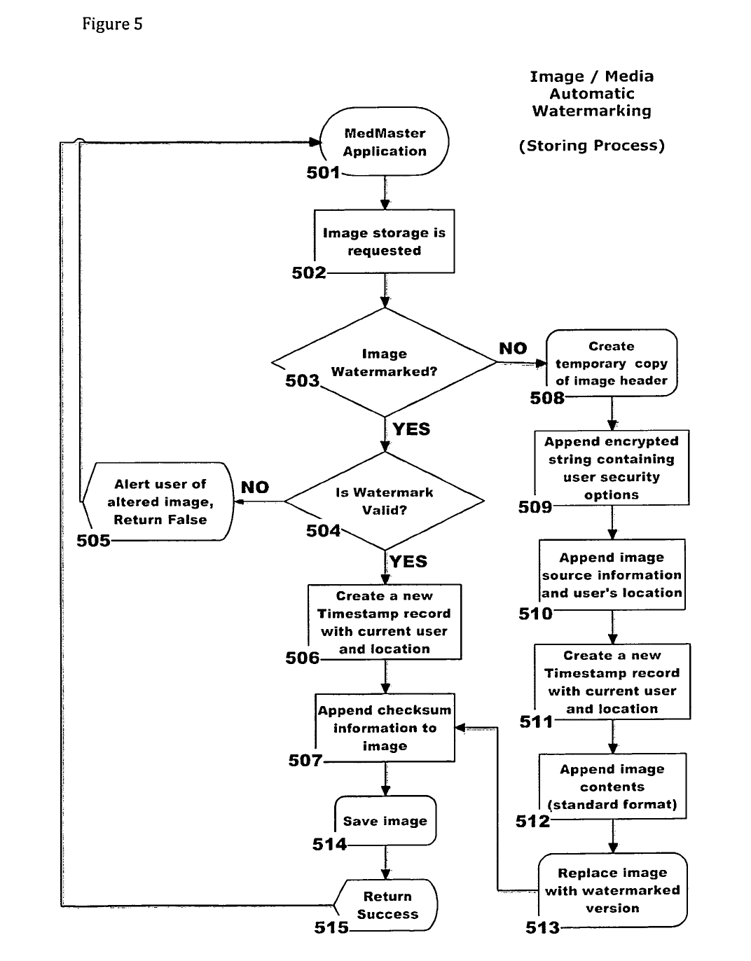

FIG. 5 illustrates AUTOMATIC ENCRYPTED WATERMARK OF IMAGES. The Mobile Medical Information software includes the ability to use an integrated camera or photo connection to capture medical images. When these images are obtained, the mobile medical information software uses an algorithm to create a unique identifier for the image that also includes a checksum of the image. This identifier is then encrypted and stored within the image. This hidden “watermark” is not displayed in the image.

When an image is opened, the mobile medical information software will check for this hidden watermark and verify that the image has not been altered. This security feature can be used to assure that images are authentic and not doctored. This feature can result in reducing insurance fraud, and reduce malpractice claims.

In an embodiment of the invention, 501 the mobile medical information software 502 requests an image from the medical information server. The medical information software 503 determines if the image contains an embedded watermark.

If the image has an invalid watermark, 505 the mobile medical information system alerts the user of the possible altered or forged image.

If the image does not contain a watermark, 508 a temporary copy of the image header is created and 509 a secure tokenized string is created. 510 information regarding the image source and users location (GPS co-ordinates, and defined location) is 511 combined with a time stamp and current geo-location information to create a new header string. This header is combined 512 with the standard image contents and 513 saved as image with an embedded watermark (the customized header). When an image is accessed 506 a new time stamp record is created and 507 combined with a checksum and the 514 the final image saved. 515 a successful watermark update results in the image request being fulfilled.

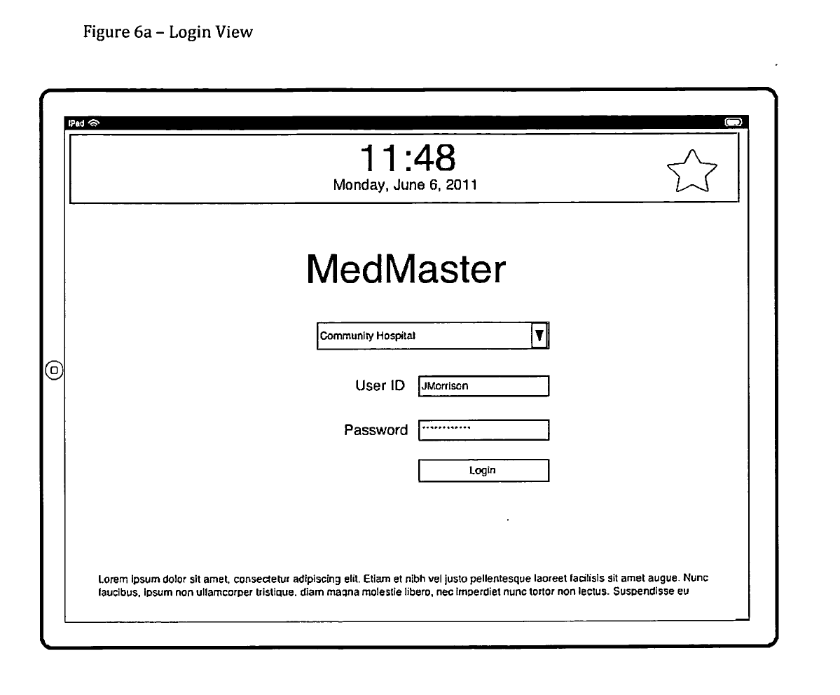

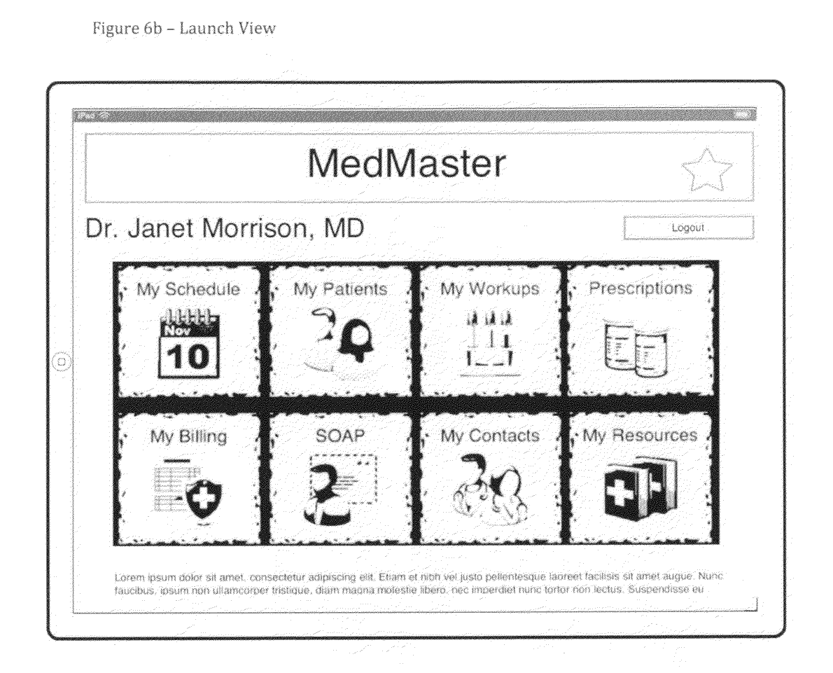

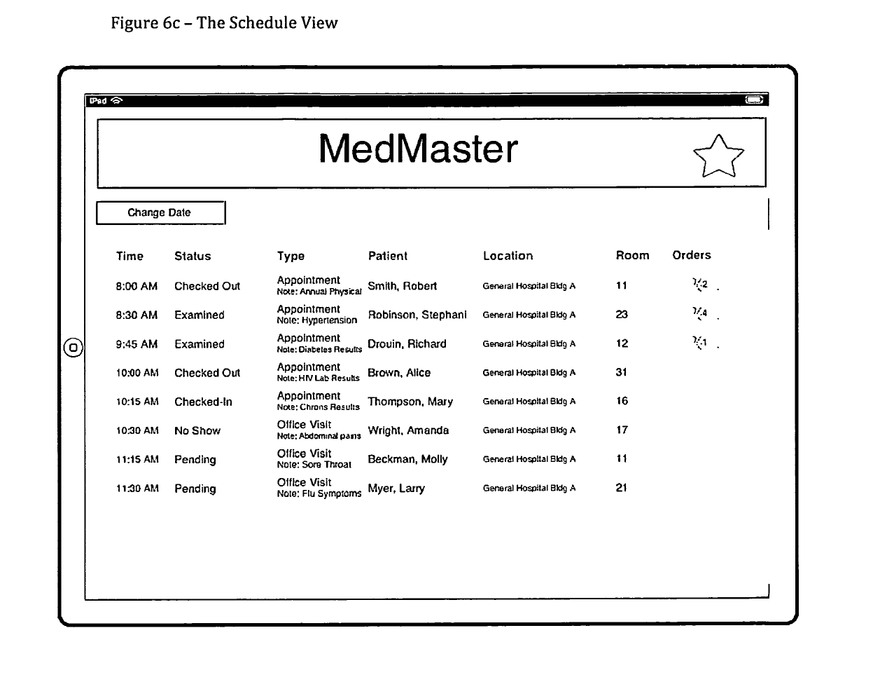

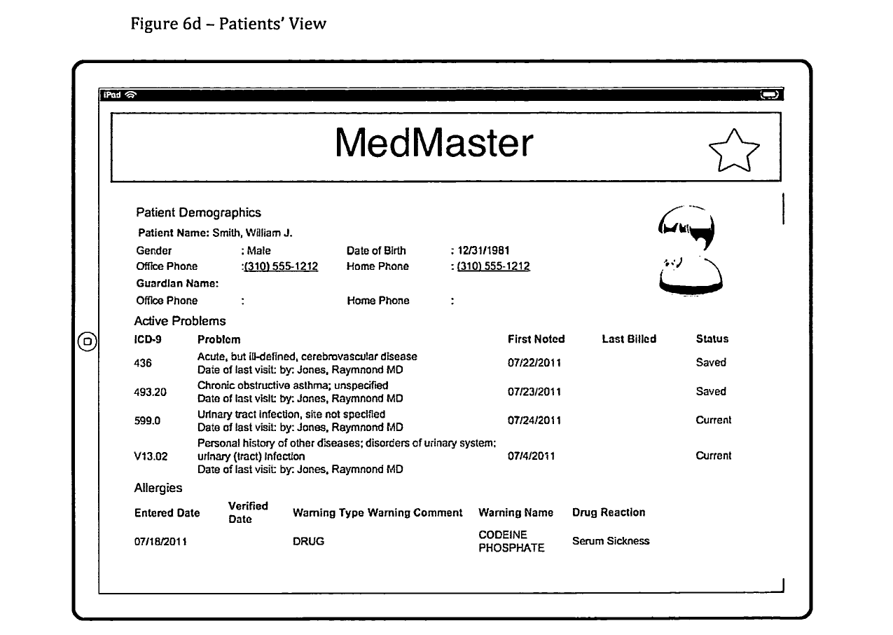

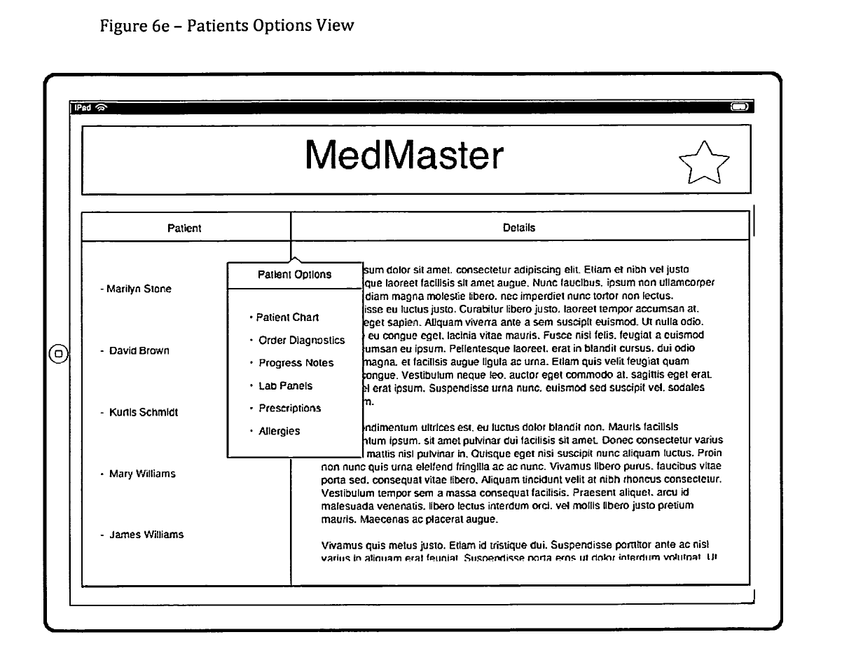

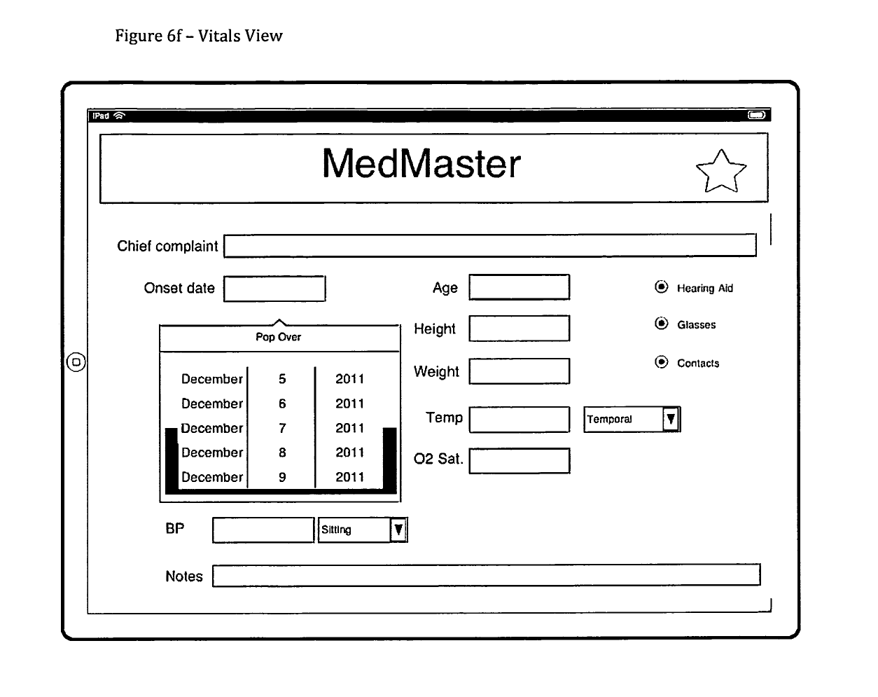

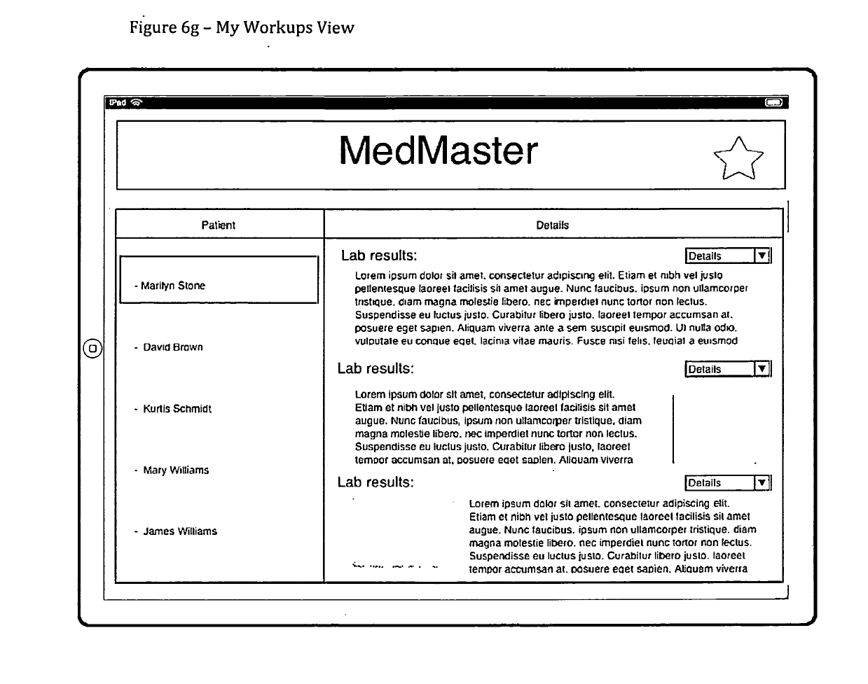

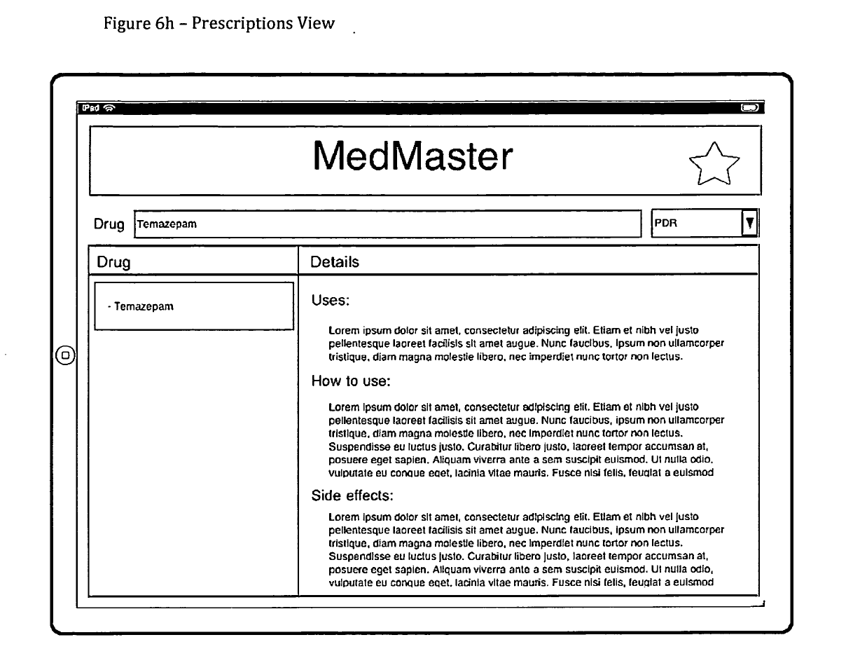

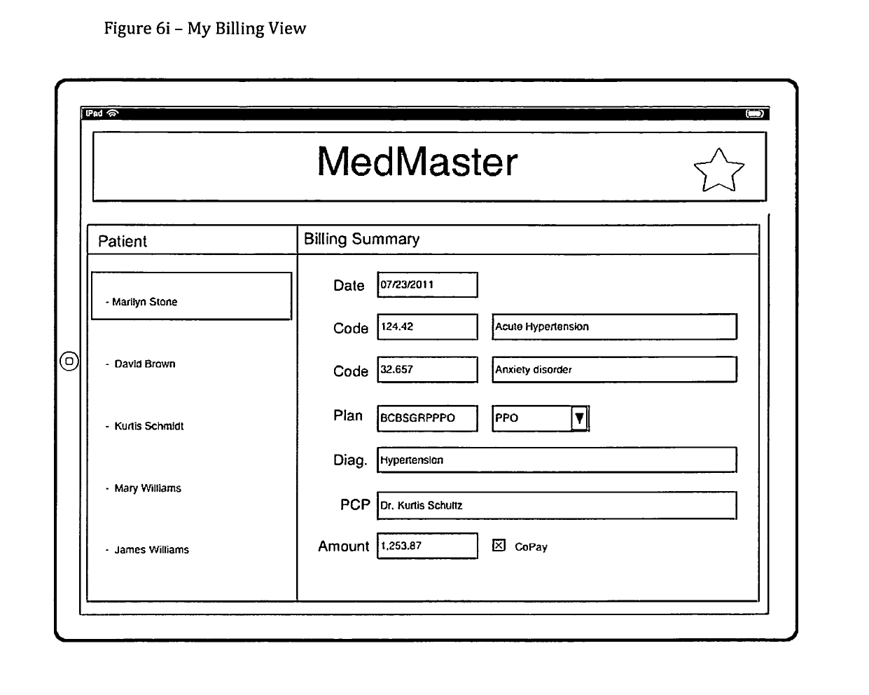

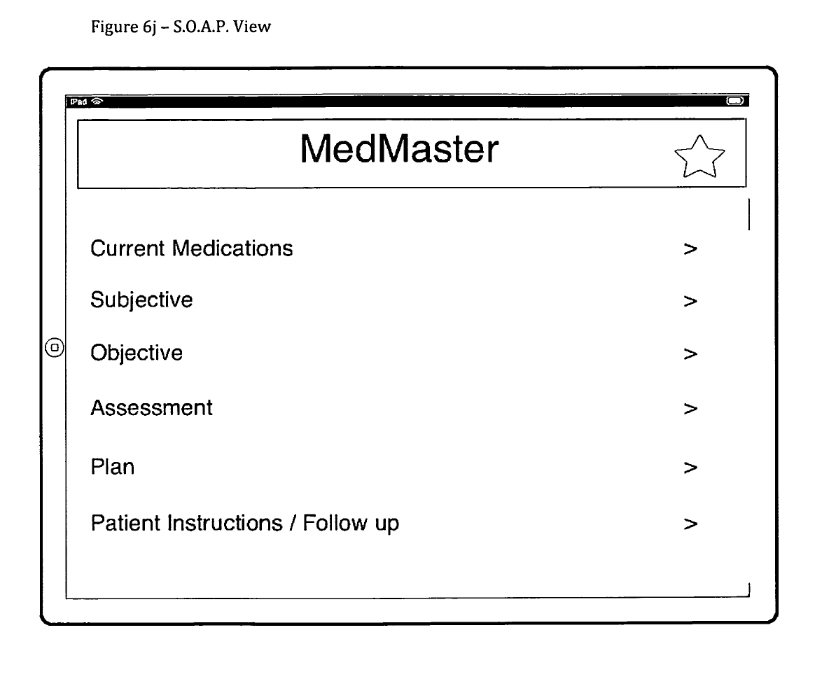

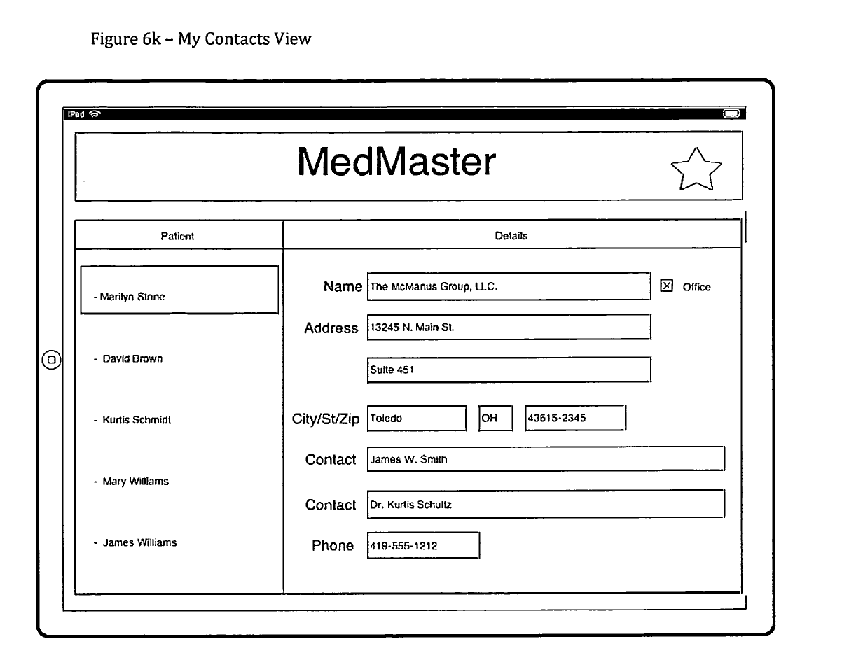

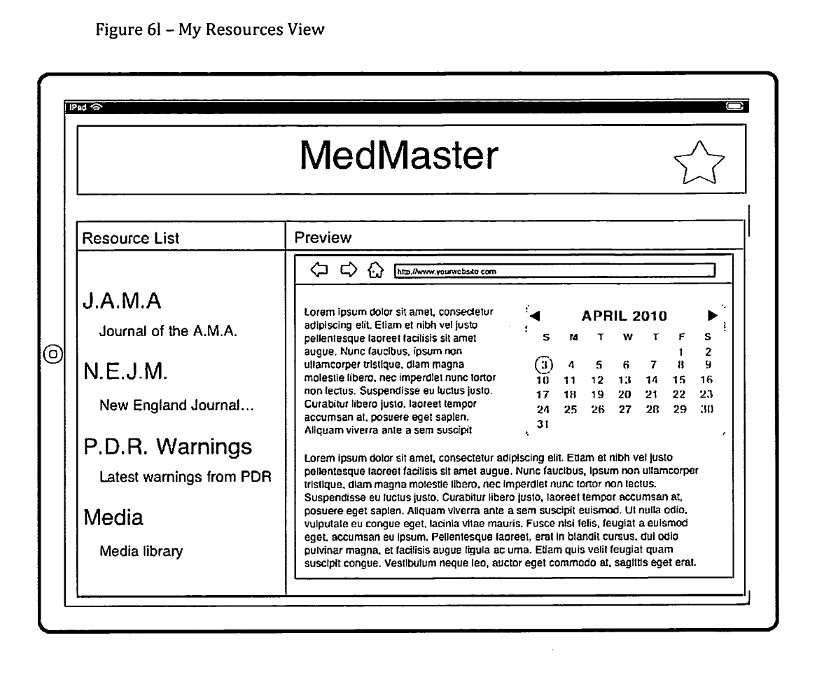

FIG. 6a illustrates THE LOGIN VIEW. Being EHR-agnostic, MedMaster Mobility conveniently serves as a native mobile tablet device standardized mobile front-end solution to existing HIT systems without the need for complex re-training or expensive new technology investments.

In an embodiment of the invention, MedMaster Mobility transmits a request to display the Login View of the available Electronic Health Record (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays the Login View for selection of facility and input of User ID and User Password.

FIG. 6b illustrates THE LAUNCH VIEW. MedMaster Mobility's Launch Pad provides instant access to the most used functions using speech recognition for navigation or with just the tap of a finger on the device's screen. This view also shows the practitioner's name and current location above the eight core functions that among other workflows may include: My Schedule, My Patients, My Workups, Prescriptions, My Billing, SOAP, My Contacts, and My Resources.

In an embodiment of the invention, MedMaster Mobility transmits a request to display the Launch View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays the Launch View for the core functions of the medical software application such as but not limited to, My Schedule, My Patients, My Workups, Prescriptions, My Billing, SOAP, My Contacts, and My Resources.

FIG. 6c illustrates THE SCHEDULE VIEW. The My Schedule view allows the doctor to instantly see the patients scheduled for the day. The Status (Checked-In, Checked-Out, Examined, No Show) of each patient is color-coded. The Appointment Time, Patient Name, Location, Room Number, and Orders are also displayed.

In an embodiment of the invention, MedMaster Mobility transmits a request to display the My Schedule View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays the My Schedule view, which allows the doctor to instantly see the patients and interact with those scheduled for the day. The Status (Checked-In, Checked-Out, Examined, No Show) of each patient is color-coded. The Appointment Time, Patient Name, Location, and Room Number are also displayed.

FIG. 6d illustrates THE PATIENTS' VIEW. The Patient View is a comprehensive summary view of the patient's medical record that may be conveniently appended using speech recognition. This view displays personal information such as but not limited to Name, Sex, Date of Birth, Address, Phone, Guarantor Information, and Insurance Information.

In an embodiment of the invention, MedMaster Mobility transmits a request to display the Patient View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays among other options personal information such as Name, Sex, Date of Birth, Address, Phone, Guarantor Information, and Insurance Information.

FIG. 6e illustrates THE PATIENT OPTIONS VIEW. The Patient Options View facilitates connections to the Patient's Full Chart, Order Diagnosis, Progress Notes, Allergies, Advanced Directives, etc.

In an embodiment of the invention, MedMaster Mobility transmits a request to display the Patient Options View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the Patient Options View, which is a comprehensive view of the patient's medical record that may be conveniently appended using speech recognition.

FIG. 6f illustrates THE VITALS VIEW. The vitals taken here will automatically update the patient's record in the EHR database that the application is currently connected to and will also be available for use in the encounter notes, which may be keyed-in or dictated using the speech recognition engine.

In an embodiment of the invention, MedMaster Mobility transmits a request to display the Vitals View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the Vitals View, which is a comprehensive view of the Patient's Chief Complaint, Onset Date, Age, Height, Weight, Temperature, Blood Pressure, Pulse, etc.

FIG. 6g illustrates THE MY WORKUPS VIEW. The My Workups View defaults to show the doctor's patients with lab results that have not yet been reviewed. The labs can be plotted into graphs over selected date ranges, etc.

In an embodiment of the invention, MedMaster Mobility transmits a request to display the My Workups View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the My Workups View, which is a comprehensive view of all his patient's test results.

FIG. 6h illustrates THE PRESCRIPTIONS VIEW. The Prescriptions View defaults to show the patient's Problem List and Medications.

In an embodiment of the invention, MedMaster Mobility transmits a request to display the Prescriptions View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the Prescriptions View to Add New Problem, Add New Diagnosis, and Add New Prescription.

FIG. 6i illustrates THE MY BILLING VIEW. The My Billing View defaults to show a list of patients on the left side of the screen, and on the right the ability to enter appropriate billing codes.

In an embodiment of the invention, MedMaster Mobility transmits a request to display the My Billing View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the My Billing View to select a patient from the list on the left side of the screen and then enter appropriate billing codes for the particular patient.

FIG. 6j illustrates THE S.O.A.P. VIEW. The SOAP module provides instant access to current medications, diagnostic codes, plan notes, and more. Using the built-in speech recognition, a doctor does not have to take his valuable time to type in all his S.O.A.P. notes.

In an embodiment of the invention, MedMaster Mobility transmits a request to display the S.O.A.P. View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with a patient's current Medications, Objectives, Assessment Notes, Plan Notes, Patient Instructions/Follow up, and NQF Measure Codes.

FIG. 6k illustrates THE MY CONTACTS VIEW. The My Contacts View may be divided into two or more groups such as Professional Connections and General Contacts.

In an embodiment of the invention, MedMaster Mobility transmits a request to display the My Contacts View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the various contact groups the doctor has selected. For example, Professional Connections could be his go-to radiology lab or pharmacy, where as General Contacts could be his golf buddies or his favorite Italian restaurant.

FIG. 6l illustrates THE MY RESOURCES VIEW. The My Resources View provides instant access to answers to everyday legal questions with PDRs, ICD, CPT/HPCS and ARUP, along with office credentialing.

In an embodiment of the invention, MedMaster Mobility transmits a request to display the My Resources View of the available Electronic Health Records (EHR) or Electronic Medical Records (EMR) systems whether local or cloud-based and regardless of which legacy Health Information Technology (HIT) is in use at the facility. After receiving a confirmation that the user has valid credentials to connect to the selected EHR or EMR system server, MedMaster Mobility connects based on that confirmation.

It may also request a connection to a selected Health Information Exchange (HIE) server that is specifically designed for HL7 message integration, whether local or cloud-based.

Once connected, MedMaster Mobility displays and allows interaction with the various third-party resources the doctor has selected for his particular practice. For example, a doctor may want links to the Journal of the A.M.A., A.M.A. Legal Guidelines, New England Journal of Medicine, American Dental Association, or Centers for Disease Control.

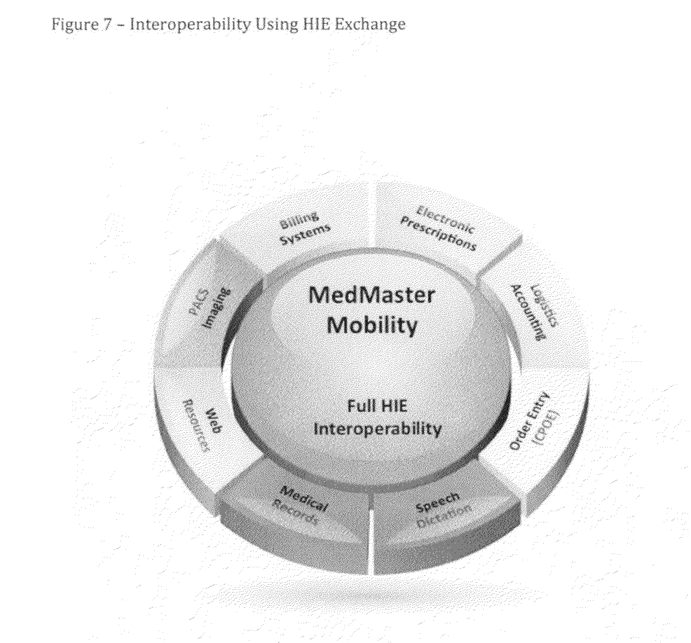

FIG. 7 illustrates MEDMASTER MOBILITY CONNECTIVITY TO HIE EXCHANGE SERVER.

In an embodiment of the invention, MedMaster Mobility displays and allows connectivity to an exchange server based on confirmation that the user has valid credentials to connect. The HIE server may include among other options Electronic Prescriptions, Logistics Accounting, Order Entry (CPOE), Speech Dictation, Medical Records, Web Resources, PACS Imaging, and Billing Systems.

1. A computer-implemented method whether using local or cloud-based server for a portable electronic device operating in a healthcare environment, the portable electronic device including a memory and a processor, the memory storing instructions which when executed by the processor, cause the portable electronic device via Wi-Fi if Wi-Fi is not available or in the alternative on a cellular phone network but not using a Remote Desktop type connection to:
transmit a request to display the Login View of the available Electronic Health Records (EHR) or Electronic Medical Records (EMR) systems whether local or cloud-based and regardless of which legacy Health Information Technology (HIT) is in use at the facility;
request a connection to a selected EHR or EMR system server, whether local or cloud-based and regardless of which legacy Health Information Technology (HIT) is in use at the facility;
receive confirmation that the user has valid credentials to connect to the selected EHR or EMR system server;
receive connection to the selected EHR or EMR system server, whether or not the healthcare provider uses Epic, Allscripts, Cerner, GE Healthcare, Open EMR, Open Vista, World Vista, Practice Fusion, NextGen, or any of the other leading EHR or EMR solution;
provide optional seamless and effortless connections to a Health Information Exchange (HIE) platform that is specifically designed for HL7 message integration;
assure safe and secure delivery in a standardized MedMaster Mobility mobile tablet device interface of the six critical rights of information management and exchange: getting the right information to the right person at the right time in the right place in the right format for the right value, even from different HIE systems from anywhere at anytime;
reduce overhead by optimizing the use of staff and capital resources throughout the healthcare chain;
allow access and interact with the various fully customizable core functions with the EHR or EMR; and
display the Launch View for the core functions of the medical software application such as but not limited to, My Schedule, My Patients, My Workups, Prescriptions, My Billing, SOAP, My Contacts, and My Resources.

2. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the user's daily schedule using the My Schedule View;
receive connection to the selected EHR or EMR system server; and
display the My Schedule view which allows the doctor to instantly see the patients and interact with those scheduled for the day. The Status (Checked-In, Checked-Out, Examined, No Show) of each patient is color-coded. The Appointment Time, Patient Name, Location, and Room Number are also displayed.

3. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's patients using the My Patients View;
receive connection to the selected EHR or EMR system server;
display and interact with the Patient Chart view which is a comprehensive view of the patient's medical record that may be conveniently appended using speech recognition. Each of the active problems, lab results, among others is selectable to see the full details and reports; and
display and interact with personal information, insurance information, and guarantor information. Using speech recognition for navigation or the tap of a finger a doctor can access the Patient's Full Chart, Orders, Progress Notes, Allergies, and to Prescribe Medications, Admit Patient, Refer a Patient, Excuse Slips, and Advanced Directives, among other options,

4. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's workups using the My Workups View;
receive connection to the selected EHR or EMR system server; and
display and interact with the My Workups View.

5. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's patients' prescriptions using the Prescriptions View;
receive connection to the selected EHR or EMR system server; and
display and interact with patient Prescriptions.

6. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's billing module using the My Billing View;
receive connection to the selected EHR or EMR system server; and
display and interact with the billing module for payment and payment options selected.

7. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's encounter with his patients using the S.O.A.P. View;
receive connection to the selected EHR or EMR system server; and
display and interact with the S.O.A.P. View, which includes a Subjective and Objective Patient Assessment followed by Treatment Plan.

8. The computer-implemented method of claim 1 whether using local or cloud-based server, further includes instructions, which when executed cause the processor via Wi-Fi if Wi-Fi is not available or in the alternative on a cellular phone network but not using a Remote Desktop type connection to:
transmit a request to display and interact with the doctor's professional and personal contacts using the My Contacts View;
receive connection to the selected EHR or EMR system server; and
display and interact with the My Contacts View.

9. The computer-implemented method of claim 1 whether using local or cloud-based server, further includes instructions, which when executed by the processor cause the portable electronic device via Wi-Fi if Wi-Fi is not available or in the alternative on a cellular phone network but not using a Remote Desktop type connection to:
transmit a request to display and interact with the doctor's selected external links or native videos using the My Resources View;
receive connection to the selected EHR or EMR system server;
display and interact with the My Resources View.

10. The computer-implemented method for claims 1 though 9 whether using local or cloud-based server further includes instructions which when executed by the processor, causes the computing device deploy via Wi-Fi if Wi-Fi is not available or in the alternative on a cellular phone network but not using a Remote Desktop type connection to:
transmit a request to engage medical speech recognition for purposes of dictation and navigation;
receive connection to bi-directional audio from speech recognition software; and
transmits first to the built-in Remote Desktop receiver using MedMaster Mobility and that receiver in turn takes that audio and sends it to the host application that resides on a Remote Desktop server.

11. The computer-implemented method for claims 1 though 9 whether using local or cloud-based server further includes instructions which when executed by the processor, causes the computing device deploy via Wi-Fi if Wi-Fi is not available or in the alternative on a cellular phone network but not using a Remote Desktop type connection to:
transmit a request to engage medical speech recognition for purposes of dictation and navigation;
receive connection to bi-directional audio from speech recognition software;
capture the uniqueness of each patient encounter and document the clinical decision-making process without the limitations of rigid documentation templates;
help physicians capture all the information needed for coding in ICD-10, in real time, at the point of documentation without manual data entry;
create ICD-9-compliant clinical documentation and streamlines the transition from ICD-9 to ICD-10;
identify key patient data and automatically saves it as structured data in the EHR's database, where information can be analyzed, reported and used for better patient care;
analyze free text dictation, and then tags the most important clinical data elements such as medications, problems, social history, allergies, and procedures;
streamline EHR population from the narrative by automatically extracting clinical facts from dictation and then placing that data into the appropriate fields in each respective form facilitate more accurate coding;
finish notes more quickly, thus enabling more one-on-one time with patients, which enhances patient satisfaction and outcomes;
ensure that the spelling of some inanely spelled medication will be correct;
preserve the patient's unique clinical story by eliminating point-and-click and reliance on keyboard and mouse;
enable physicians to document their clinical decision making processes;
integrate into physician and enterprise workflows;
support compliance with CCHIT EHR certification criteria; and
dictate the chart note in the room with the patient sitting there, print it out, and then hand the patient a copy right then and there.

12. A computer-implemented method for claims 1 though 9 whether using local or cloud-based server for a portable electronic device operating in a healthcare environment, the portable electronic device including a memory and a processor, the memory storing instructions which when executed by the processor, cause the portable electronic device via Wi-Fi if Wi-Fi is not available or in the alternative on a cellular phone network but not using a Remote Desktop type connection for interoperability to:
facilitate Computerized Physician Order Entry (CPOE);
facilitate Clinical Decision Support (CDS);
facilitate Picture Archiving along with Communications Systems (PACS);
facilitate E-prescribing

13. A computer-implemented method for claims 1 though 9 whether using local or cloud-based server for a portable electronic device operating in a healthcare environment, the portable electronic device including a memory and a processor, the memory storing instructions which when executed by the processor, cause the portable electronic device via Wi-Fi if Wi-Fi is not available or in the alternative on a cellular phone network but not using a Remote Desktop type connection to:
allow patients to interact with their practitioner by email or video chat, and to view test results and upcoming & past appointments, schedule appointments, pay bills securely and saving phone calls and mailing expenses, get automated health maintenance reminders, request refills, manage the care of elderly parents, and access benefit and eligibility information, referral authorizations and account balances;
allow healthcare entities to implement as well as execute cost-containment strategies such as cost-effective revenue cycle processes, more efficient management of patients within systems, reduction of the accreditation and credentialing steps;
provide a wealth of information at the time and place of care; and
provide reliable and accurate patient history, enables providers to perform a more accurate, focused patient evaluations, reduced costs to patients and healthcare system, and improved overall patient care.

14. A computer-implemented method for claims 1 though 9 whether using local or cloud-based server for a portable electronic device operating in a healthcare environment, the portable electronic device including a memory and a processor, the memory storing instructions which when executed by the processor, cause the portable electronic device via Wi-Fi if Wi-Fi is not available or in the alternative on a cellular phone network but not using a Remote Desktop type connection to facilitate connectivity by using existing API's. This would be a SOAP or REST solution that would:
create a connection to API server;
send request to API; and
receive and parse the results.

15. A computer-implemented method for claims 1 though 9 whether using local or cloud-based server for a portable electronic device operating in a healthcare environment, the portable electronic device including a memory and a processor, the memory storing instructions which when executed by the processor, cause the portable electronic device via Wi-Fi if Wi-Fi is not available or in the alternative on a cellular phone network but not using a Remote Desktop type connection to facilitate connectivity by creating an extremely thin middleware service to reside on a server. This thin client would be a REST solution, its functions are:
create/maintain a connection to the appropriate database
receive requests (via PHP or otherwise)
pass SQL/Query statement directly to the database receive the results
return XML or JSON response
